(19) United States
(12) Patent Application Publication
(10) Pub. No.: US 2012/0201935 A1
(43) Pub. Date: Aug. 9, 2012

(54) SWEETNESS ENHANCER, SWEETENER COMPOSITIONS, METHODS OF MAKING THE SAME AND CONSUMABLES CONTAINING THE SAME

(75) Inventors: Michael Krohn, Lorsch (DE); Simon Seibert, Darmstadt (DE); Alice Kleber, Bensheim (DE)

(73) Assignee: NUTRINOVA NUTRITION SPECIALTIES & FOOD INGREDIENTS GMBH, Sulzbach (DE)

(21) Appl. No.: 13/368,051

(22) Filed: Feb. 7, 2012

Related U.S. Application Data
(60) Provisional application No. 61/440,743, filed on Feb. 8, 2011.

(30) Foreign Application Priority Data
Feb. 8, 2011 (EP) 11011009.7-2114

(51) Int. Cl. A23L 1/236

(52) U.S. Cl. 426/96; 426/548

(57) ABSTRACT

The present invention relates to the use of rosmarinic acid as a sweetness enhancer, to sweetener compositions comprising a sweetener and rosmarinic acid, to methods of making the sweetener compositions and to tabletop sweetener compositions comprising rosmarinic acid. Further, the invention relates to consumables comprising a consumable product and rosmarinic acid. Preferred consumable products are water-based consumables, solid dry consumables, dairy products, dairy-derived products and dairy-alternative products.

### CROSS REFERENCE TO RELATED APPLICATIONS

This application claims priority to U.S. Provisional Application No. 61/440,743, which was filed on Feb. 8, 2011 and to EP Application No. 11 011 009.7-2114, which was filed on Feb. 8, 2011. The entireties of these applications are hereby incorporated by reference.

### FIELD OF THE INVENTION

The present invention relates to the use of rosmarinic acid as a sweetness enhancer, to sweetener compositions comprising a sweetener and rosmarinic acid, to methods of making the sweetener compositions and to tabletop sweetener compositions comprising rosmarinic acid. Further, the invention relates to consumables comprising a consumable product and rosmarinic acid. Preferred consumable products are water-based consumables, solid dry consumables, dairy products, dairy-derived products and dairy-alternative products.

### BACKGROUND OF THE INVENTION

The use of non-caloric high-intensity sweeteners is increasing due to health concerns raised over childhood obesity, type II diabetes, and related illnesses. Thus, a demand exists for sweeteners having sweetnesses significantly higher than those of conventional sweeteners, such as granulated sugar (sucrose). Many non-caloric or low-caloric sweeteners, however, are prohibitively expensive and/or contain unpleasant off-flavors and/or have unexpected and less-than-desirable sweetness profiles.

Therefore, it is of interest to enhance desired flavor sensations, e.g., sweet taste, of non-caloric or low-caloric sweeteners.

Compounds that can enhance certain flavor sensations are of great interest and may allow not only improvement and/or intensification of the perceived flavor but also the ability to reach a certain flavor intensity using reduced concentrations of flavor ingredients As one example, by employing an enhancer, less sweetener may be necessary to achieve a desired sweetness level, which may result in less calories and/or associated undesirable flavor notes/off-notes.

### BRIEF DESCRIPTION OF THE FIGURES

FIG. 1 is a chart showing the results of the recombinant human taste receptor T1R2/T1R3 dependent cell based assay with rosmarinic acid.

FIG. 2 is a chart showing that the selective stimulation of receptor carrying cells by rosmarinic acid is verified by measuring the time response in the cell assay over a period of 85 seconds.

FIG. 3 is a table summarizing the results of the taste and spit assay with rosmarinic acid.

### SUMMARY OF THE INVENTION

The present invention, in one aspect. relates to the use of rosmarinic acid or a derivative or a stereoisomer or a salt or a hydrate thereof as a sweetness enhancer.

In another aspect, the present invention relates to a sweetener composition comprising:
(a) a sweetener; and
(b) rosmarinic acid or a derivative or a stereoisomer or a salt or a hydrate thereof.

Preferably, in the sweetener composition rosmarinic acid or a derivative or a stereoisomer or a salt thereof are a sweetness enhancer.

In one embodiment, the sweetener composition comprises a sweetener which is selected from the group consisting of sucrose, fructose, glucose, high fructose corn syrup, xylose, arabinose, rhamnose, erythritol, xylitol, mannitol, sorbitol, inositol, acesulfame potassium, aspartame, neotame, sucralose, saccharine, saccharine derivatives, naringin dihydrochalcone (NarDHC), neohesperidin dihydrochalcone (NDHC), rubusoside, rebaudioside, stevioside, mogroside IV, siamenoside I, mogroside V, iso-mogroside V and trilobtain.

Preferably, the sweetener composition comprises a first sweetener and a second sweetener.

Preferably, the sweetener is a natural sweetener.

In other embodiments, the sweetener is an artificial sweetener.

In another embodiment, the sweetener composition comprises rosmarinic acid or a derivative or a stereoisomer or a salt or a hydrate thereof in a purity of greater than about 60% by weight, e.g., greater than about 70% by weight, greater than about 80% by weight, greater than about 90% by weight, greater than about 98% by weight, or greater than about 99% by weight.

In one embodiment, one gram portion of the sweetener composition provides sweetness comparable to from one to three teaspoons, preferably two teaspoons, of granulated sugar.

In another embodiment, one gram of the sweetener composition contains less calories and carbohydrates than about 1 gram of granulated sugar.

Preferably, the sweetener composition further comprises at least one ingredient selected from bulking agents, carriers, fibers, sugar alcohols, flavorings, flavor enhancers, flavor stabilizers, acidulants, anti-caking and free-flow agents.

The invention, in another aspect, relates to a tabletop sweetener composition comprising
(a) a disaccharide carbohydrate and/or fructose;
(b) erythritol;
(c) rosmarinic acid or a derivative or a stereoisomer or a salt or a hydrate thereof; and
(d) a taste-improving amount of cellulose.

In preferred embodiments, in the tabletop sweetener composition the disaccharide carbohydrate is selected from the group consisting of sucrose, lactose, maltose, trehalose, and isomaltulose.

Preferably, the tabletop sweetener composition comprises between about 40% by weight and about 70% by weight erythritol, in particular between about 50% by weight and about 60% by weight erythritol, in particular about 55% by weight erythritol.

Preferably, the tabletop sweetener composition comprises between about 27% by weight and about 50% by weight disaccharide carbohydrate, in particular between about 35% by weight and about 45% by weight disaccharide carbohydrate, in particular between about 30% by weight and about 40% by weight disaccharide carbohydrate.

Preferably, the tabletop sweetener composition comprises between about 0.5% by weight and about 7.0% by weight of rosmarinic acid or a derivative or a stereoisomer or a salt or a hydrate thereof, in particular between about 0.7% by weight and 5.0% by weight of rosmarinic acid or a derivative or a stereoisomer or a salt or a hydrate thereof, in particular between about 1.0% by weight and about 2.5% by weight of rosmarinic acid or a derivative or a stereoisomer or a salt or a hydrate thereof.

Preferably, the tabletop sweetener composition comprises between about 0.4% by weight and about 3.0% by weight cellulose, in particular between about 0.7% by weight and about 2.0% by weight cellulose, in particular about 1.0% by weight cellulose.

In one embodiment, the tabletop sweetener composition further comprises a sweetness modifier, in particular less than about 2% by weight of a sweetness modifier. In terms of ranges, the tabletop sweetener composition may, for example, comprise between about 0.01% by weight and about 2% by weight sweetness modifier, in particular between about 0.1% by weight and about 1.5% by weight sweetness modifier.

In other embodiments, the tabletop sweetener composition further comprises a mouthfeel enhancer, in particular less than about 1% by weight of a mouthfeel enhancer. In terms of ranges, the tabletop sweetener composition may, for example, comprise between about 0.01% by weight and about 1% by weight mouthfeel enhancer, in particular between about 0.1% by weight and about 0.5% by weight mouthfeel enhancer.

In other embodiments, the tabletop sweetener composition further comprises a flavoring, in particular less than about 1% by weight of a flavoring. In terms of ranges, the tabletop sweetener composition may, for example, comprise between about 0.01% by weight and about 1% by weight flavoring, in particular between about 0.1% by weight and about 0.5% by weight flavoring.

In one embodiment, the tabletop sweetener composition substantially comprises sweetener particles.

Preferably, the sweetener particles have an average particle size of between about 50 microns and about 1250 microns, in particular the sweetener particles have an average particle size of between about 100 microns and about 1000 microns.

In one embodiment, the tabletop sweetener composition has less than about 5 calories per gram, in particular the tabletop sweetener composition has less than about 3 calories per gram, in particular the sweetener composition has less than about 1 calorie per gram.

The present invention, in another aspect, further relates to a tabletop sweetener composition comprising
(a) a plurality of first sweetener particles, wherein the first sweetener particles have (i) an erythritol core, (ii) a first erythritol core-coating layer comprising rosmarinic acid or a derivative or a stereoisomer or a salt or a hydrate thereof and cellulose, and (iii) a second erythritol core-coating layer comprising a disaccharide carbohydrate, where the second erythritol core-coating layer lies outside of the first erythritol core-coating layer; and
(b) a plurality of second sweetener particles, where the second sweetener particle has (i) a disaccharide core, (ii) a first disaccharide core-coating layer comprising rosmarinic acid or a derivative or a stereoisomer or a salt or a hydrate thereof and cellulose, and (iii) a second disaccharide core-coating layer comprising a disaccharide carbohydrate, where the second disaccharide core-coating layer lies outside of the first disaccharide core-coating layer.

In one embodiment, the tabletop sweetener composition comprises a mixture of the plurality of first sweetener particles and the plurality of second sweetener particles.

Preferably, the disaccharide core comprises isomaltulose.

In one embodiment, the second erythritol core-coating layer comprises isomaltulose.

In one embodiment, the second disaccharide core-coating layer comprises isomaltulose.

In one embodiment, the first erythritol core-coating layer and the first disaccharide core-coating layer further comprise a flavoring.

In one embodiment, the first erythritol core-coating layer and the first disaccharide core-coating layer further comprise a mouthfeel enhancer.

In one embodiment, the first erythritol core-coating layer and the first disaccharide core-coating layer further comprise a sweetness modifier.

Preferably, the plurality of first sweetener particles and the plurality of second sweetener particles have an average particle size between about 50 microns and about 1250 microns, in particular, the plurality of first sweetener particles and the plurality of second sweetener particles have an average particle size between about 100 microns and about 1000 microns.

In another aspect, the present invention further relates to a consumable comprising
(a) a consumable product; and
(b) a sweetener composition of the invention as defined above or a tabletop sweetener composition of the invention as defined above.

Preferably, the sweetener composition of the invention and the tabletop sweetener composition of the invention are present in the consumable in an amount effective to increase a sweetness level of the consumable.

Preferably, in the consumable of the invention rosmarinic acid or a derivative or a stereoisomer or a salt or a hydrate thereof is present in a concentration from 0.1 wppm to 100 wppm, in particular 0.2 wppm to 50 wppm, particularly preferred from 0.5 wppm to 10 wppm.

In one embodiment, the consumable product is selected from water-based consumables, solid dry consumables, dairy products, dairy-derived products and dairy-alternative products.

Preferably, the consumable product is a water-based consumable selected from the group consisting of beverage, water, aqueous beverage, enhanced/slightly sweetened water drink, mineral water, carbonated beverage, non-carbonated beverage, carbonated water, still water, soft drink, non-alcoholic drink, alcoholic drink, beer, wine, liquor, fruit drink, juice, fruit juice, vegetable juice, broth drink, coffee, tea, black tea, green tea, oolong tea, herbal tea, cacoa (water-based), tea-based drink, coffee-based drinks, cacao-based drink, syrup, frozen fruit, frozen fruit juice, water-based ice, fruit ice, sorbet, dressing, salad dressing, sauce, soup, and beverage botanical materials (whole or ground), or instant powder for reconstitution (coffee beans, ground coffee, instant coffee, cacao beans, cacao powder, instant cacao, tea leaves, instant tea powder).

Preferably, the consumable product is a solid dry consumable selected from the group consisting of cereals, baked food products, biscuits, bread, breakfast cereal, cereal bar, energy bars/nutritional bars, granola, cakes, rice cakes, cookies, crackers, donuts, muffins, pastries, confectioneries, chewing gum, chocolate, fondant, hard candy, marshmallow, pressed tablets, snack foods, botanical materials (whole or ground), and instant powders for reconstitution.

Preferably, the consumable product is a dairy product, dairy-derived product and/or dairy-alternative product selected from the group consisting of milk, fluid milk, cultured milk product, cultured and noncultured dairy-based drink, cultured milk product cultured with lactobacillus, yoghurt, yoghurt-based beverage, smoothy, lassi, milk shake, acidified milk, acidified milk beverage, butter milk, kefir, milk-based beverages, milk/juice blend, fermented milk beverage, icecream, dessert, sour cream, dip, salad dressing, cottage cheese, frozen yoghurt, soy milk, rice milk, soy drink, and rice milk drink.

In one embodiment, the consumable product is a carbonated drink.

In one embodiment, the consumable product is a non-carbonated drink.

In one embodiment, the consumable product is a cereal.

In one embodiment, the consumable product is a yoghurt.

In one embodiment, the consumable product is a chewing-gum.

Preferably, the consumable product is a dental product selected from the group consisting of toothpaste, dental floss, mouthwash, denture adhesive, enamel whitener, fluoride treatments and oral care gels, particularly preferred toothpaste.

Preferably, the consumable product is a cosmetic product selected from the group consisting of lipstick, lip balm, lip gloss and petroleum jelly.

Preferably, the consumable product is a pharmaceutical product selected from the group consisting of over-the-counter and prescription drugs, non-tobacco snuff, tobacco substitutes, chewable medications, cough syrups, throat sprays, throat lozenges, cough drops, antibacterial products, pill coatings, gel caplets, soluble fiber preparations, antacids, tablet cores, rapidly absorbed liquid compositions, stable foam compositions, rapidly disintegrating pharmaceutical dosage forms, beverage concentrates for medicinal purposes, aqueous pharmaceutical suspensions, liquid concentrate compositions, and stabilized sorbic acid solutions, phosphate buffers, saline solutions, emulsion, non-aqueous pharmaceutical solvents, aqueous pharmaceutical carriers, solid pharmaceutical carrier, and pharmaceutical preservatives/additives (antimicrobials, antioxidants, chelating agents, inert gases, flavoring agents, coloring agents).

In one embodiment, the consumable product is an animal feed or animal food.

The invention, in another aspect, further relates to a method of providing a consumable of the invention as defined above by admixing a sweetener composition of the invention as defined above or a tabletop sweetener composition of the invention as defined above to a consumable product.

The invention, in another aspect, further relates to a method of enhancing the taste sensations associated with flavor ingredients by admixing a sweetener composition of the invention as defined above or a tabletop sweetener composition as defined above with one or more flavor ingredients to provide a flavor-enhanced composition or consumable.

The invention, in another aspect, further relates to a method of increasing a sweetness level of a consumable having an initial sweetness level comprising the step of adding to the consumable rosmarinic acid in an amount effective to increase the sweetness level of the consumable to a final sweetness level.

### DETAILED DESCRIPTION OF THE INVENTION

### Use of Rosmarinic Acid as a Sweetness Enhancer

As indicated above, there is a need for alternative sweetness enhancers which are healthy, i.e. non-caloric, non-cariogenic and ideal for diabetics. Also, the need exists for sweetness enhancers having an excellent temperature and pH stability, excellent storage and solubility properties as well as a taste-enhancing effects and synergies when combined with other sweetening compounds. In particular, novel sweetness enhancers that are derived from natural products are of great interest. It is therefore an object of the present invention to provide an alternative sweetness enhancer having the above mentioned desired characteristics.

It has now been found that rosmarinic acid or a derivative or a stereoisomer and salts or hydrates thereof are sweetness enhancers.

Thus, in one aspect, the invention relates to the use of rosmarinic acid or a salt or a hydrate thereof as a sweetness enhancer.

Rosmarinic acid is a natural constituent found in many Lamiaceae herbs, but is also found in other species, e.g. the hornwort Anthoceros, the fern Blechnum and in Mentha longifolia. Rosmarinic acid is commercially available and has been e.g. described by M. J. Parnham et al., (M. J. Parnham et al., Drugs of the Future, 1985, 10, 756, which is incorporated by reference in its entirety), and by T. Eicher et al., (T. Eicher et al., Synthesis, 1996, 755, which is incorporated by reference in its entirety).

Rosmarinic acid is an ester formed via the esterification of caffeic acid with 3,4-dihydroxyphenyl lactic acid. The IUPAC name of rosmarinic acid is (2R)-2-[[(2E)-3-(3,4-Dihydroxyphenyl)-1-oxo-2-propenyl]]oxy]-3-(3,4-dihydroxyphenyl)propanoic acid.

Rosmarinic acid has the chemical structure of the formula (I) (cf. Römpp Lexikon Chemie, 1999, 10^{th} edition, Georg Thieme Verlag, Stuttgart)

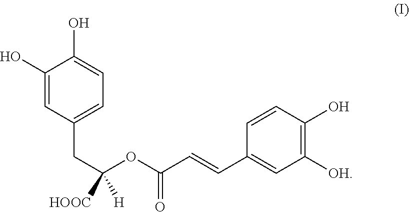

As used herein, the term “salts” of rosmarinic acid or a derivative thereof means the physiologically acceptable acid addition salts and base salts of rosmarinic acid. Suitable acid addition salts are formed from acids which form non-toxic salts. Examples include but are not limited to the acetate, aspartate, benzoate, besylate, bicarbonate, carbonate, bisulphate, sulphate, borate, camsylate, citrate, edisylate, esylate, formate, fumarate, gluceptate, gluconate, glucuronate, hexafluorophosphate, hibenzate, hydrochloride/chloride, hydrobromide, bromide, hydroiodide, iodide, isethionate, lactate, malate, maleate, malonate, mesylate, methylsulphate, naphthylate, nicotinate, nitrate, orotate, oxalate, palmitate, pamoate, phosphate, hydrogen phosphate, dihydrogen phosphate, sacharate, stearate, succinate, tartrate, tosylate and trifluoroacetate salts. Suitable base salts are formed from bases which form non-toxic salts. Examples include but are not limited to the aluminium, arginine, benzathine, calcium, choline, diethylamine, diolamine, glycine, lysine, magnesium, meglumine, olamine, potassium, sodium, tromethamine and zinc salts.

As used herein, the term “hydrates” of rosmarinic acid means rosmarinic acid or a derivative thereof that include water. “Hydrates” are formed by the addition of water or its elements. In one embodiment, rosmarinic acid may form crystals that incorporate water into the crystalline structure without chemical alteration.

As used herein, the term “stereoisomer” of rosmarinic acid or a derivative thereof encompasses any possible enantiomers, diastereomers, cis-trans-isomers and/or E-/Z-isomers of rosmarinic acid and its derivatives. In particular, the term “stereoisomer” means a single compound or a mixture of two or more compounds, wherein at least one chiral center is predominantly present in one definite isomeric form, in particular the S-enantiomer, the R-enantiomer and the racemate of rosmarinic acid or a derivative thereof. Particularly preferred is the R-enantiomer. It is also possible that two or more stereogenic centers are predominantly present in one definite isomeric form of a derivative of rosmarinic acid. In the sense of the present invention, “predominantly” has the meaning of at least 60%, preferably at least 70%, particularly preferably at least 80%, most preferably at least 90%. According to the present invention, also stereoisomers of rosmarinic acid or a derivative thereof may be present as a salt or a hydrate.

As used herein, the term “derivative” or “derivatives” of rosmarinic acid or a stereoisomer thereof means organic molecules that are structurally closely related to rosmarinic acid itself and that have similar characteristics and effects, preferably as sweetener and sweetness enhancer. In the sense of the present invention, preferred examples of derivatives of rosmarinic acid are selected from the group consisting of isorinic acid (T. Satake et al., Chem. Pharm. Bull., 1999, 47, 1444-1447, which is incorporated by reference in its entirety), the 2-O-(4-hydroxy-E-cinnamoyl), 4′-O-beta-D-glucopyranoside derivative of 3-(3,4-dihydroxyphenyl)-2-hydroxypropanoic acid (T. Satake et al., Chem. Pharm. Bull., 1999, 47, 1444-1447), the 2-O-(3,4-dihydroxy-E-cinnamoyl), 3′-O-beta-D-glucopyranoside derivative of 3-(3,4-dihydroxyphenyl)-2-hydroxypropanoic acid (3′-O-beta-D-glucopyranosylrosmarinic acid) (T. Satake et al., Chem. Pharm. Bull., 1999, 47, 1444-1447), the 2-O-(3,4-dihydroxy-E-cinnamoyl), 4′-β-beta-D-glucopyranoside derivative of 3-(3,4-dihydroxyphenyl)-2-hydroxypropanoic acid (4′-O-beta-D-glucopyranosylrosmarinic acid) (T. Satake et al., Chem. Pharm. Bull., 1999, 47, 1444-1447), Methyl rosmarinate (Y.-H. Kuo et al., J. Chin. Chem. Soc. (Taipei), 2000, 47, 241-246, which is incorporated by reference in its entirety), Ethyl rosmarinate (Y.-H. Kuo et al., J. Chin. Chem. Soc. (Taipei), 2000, 47, 241-246), Butyl rosmarinate (H. Huang et al., Planta Med., 1999, 65, 92-93, which is incorporated by reference in its entirety), salviaflaside and salviaflaside methyl ester (L. M. Zhao, Chin. Chem. Lett., 1996, 7, 449-452, which in incorporated by reference in its entirety), Z-Rosmarinic acid (X.-M. Wei et al. J. Chin. Chem. Soc. (Taipei), 2004, 51, 1043-1049, which in incorporated by reference in its entirety), the 2-O-[beta-D-glucopyranosyl+4)-3,4-dihydroxy-E-cinnamoyl], 4′-O-beta-Dglucopyanoside derivative of 3-(3,4-dihydroxyphenyl)-2-hydroxypropanoic acid, oresbiusin B, 3′ glucosylromarinic acid (E. Le Claire et al., J. Agric. Food Chem., 2005, 53, 4367-4372 and mixtures thereof. These documents are incorporated herein by reference.

As used herein, the term “enhance” means to have an effect on a particular flavor sensation in consumables or other products placed in the oral cavity which is found more pronounced (stronger, enhanced) in its taste intensity and/or which is found to have an earlier onset of the flavor sensation.

As used herein, the term “sweetness enhancer” includes rosmarinic acid or a salt or hydrate thereof or compositions comprising rosmarinic acid or a salt or a hydrate thereof capable of enhancing or intensifying the perception of sweet taste of sweetener compositions or sweetened compositions. The phrase “sweetness enhancer” is synonymous to the terms “sweet taste potentiator”, “sweetness potentiator”, and “sweetness intensifier”.

As used herein, the phrase “high intensity sweetener” means any sweetener, which may in raw, extracted, purified, or any other from, singularly or in combination thereof have a sweetness potency greater than sucrose (common table sugar) yet have comparatively less calories.

As used herein, the term “sweetener” includes all artificial and natural sweeteners, including but not limited to acesulfame potassium, aspartame, neotame, sucralose, saccharine, saccharine derivatives, erythritol, isomalt, lactitol, maltitol, maltitol syrups, sorbitol, mannitol, tagatose, xylitol, alitame, neohesperidin dihydrochalcone (NDHC), sucrose, fructose, glucose, high fructose corn syrup, xylose, arabinose, rhamnose, inositol, naringin dihydrochalcone (NarDHC), rubusoside, rebaudioside, stevioside, mogroside IV, siamenoside I, mogroside V, iso-mogroside V, trilobtain, and combinations of these sweeteners. The sweeteners are known substances and are for example described by H. Mitchell (H. Mitchell, “Sweeteners and Sugar Alternatives in Food Technology”, Backwell Publishing Ltd, 2006, which is incorporated herein by reference in its entirety) and in WO 2009/023975 A2.

As shown in the Examples, the inventors have now surprisingly and unexpectedly found that rosmarinic acid is a sweetness enhancer and has no characteristic intrinsic taste. Rosmarinic acid does not have the bitter aftertaste associated with saccharin, or the metallic, acidic, astringent or throat-burning aftertastes of other high-intensity sweeteners. In addition, rosmarinic acid does not exhibit a liquorice aftertaste.

This excellent taste profile makes rosmarinic acid desirable for use in consumables or other products placed in the oral cavity.

### Sweetener Compositions and Properties Thereof

In another aspect, the invention relates to a sweetener composition comprising
(a) a sweetener; and
(b) rosmarinic acid or a derivative or a stereoisomer or a salt or a hydrate thereof.

Preferably rosmarinic acid or a derivative or a stereoisomer or a salt or a hydrate thereof are a sweetness enhancer.

In one embodiment, the sweetener composition comprises a sweetener which is selected from the group consisting of sucrose, fructose, glucose, high fructose corn syrup, xylose, arabinose, rhamnose, erythritol, xylitol, mannitol, sorbitol, inositol, acesulfame potassium, aspartame, neotame, sucralose, saccharine, saccharine derivatives, naringin dihydrochalcone (NarDHC), neohesperidin dihydrochalcone (NDHC), rubusoside, rebaudioside, stevioside, mogroside IV, siamenoside I, mogroside V, iso-mogroside V and trilobtain.

In another embodiment, the sweetener composition comprises a first sweetener and a second sweetener.

The first sweetener is preferably fructose.

Preferably, the sweetener is a natural sweetener.

In another embodiment, the sweetener is an artificial sweetener.

In another embodiment, the sweetener composition comprises rosmarinic acid or a derivative or a stereoisomer or a salt or a hydrate thereof in a purity of greater than about 60% by weight, e.g., greater than about 70% by weight, greater than about 80% by weight, greater than about 90% by weight, greater than about 98% by weight, or greater than about 99% by weight.

Preferably, one gram portion of the sweetener composition provides sweetness comparable to from one to three teaspoons, preferably two teaspoons of granulated sugar.

For example, the compositions may contain sweetness comparable to that of granulated sugar (sucrose), and therefore can be used “spoon-for-spoon” or “cup-for-cup” in place of sugar.

As used herein, the phrase “sweetness comparable” means that an experienced sensory evaluator, on average, will determine that the sweetness presented in a first composition is within a range of 80% to 120% of the sweetness presented in a second composition. The phrase “a sweetness comparable” relates to a determination ascertained by four or more experienced sensor evaluators in a sweetness matching test (designated hereinafter as “taste and spit assay”), as discussed below. Thus, for instance, 100 mg/ml of a sweetener composition comprising rosmarinic acid provides “sweetness comparable” to 100 mg/ml of sucrose if the sweetener composition of the invention has a sweetness falling within the range of sweetness presented in 80-120 mg/ml of sucrose.

The sweetness and/or sweetness enhancing properties of a compound, in some embodiments, can be identified by an in vitro in cell based assay as described in Example 1 and in EP 1 865 316 B1 or by field effector transistor technology of e.g. Alpha MOS.

The taste of a sample of a compound, e.g. rosmarinic acid, with regard to sweetness and/or sweetness enhancing properties, in other embodiments, may be assessed in vivo by using a panel of trained sensory evaluators experienced in the sweet taste estimation procedure, e.g. in the taste and spit assay as described e.g. in Example 2.

In these cases, panelists are asked to take a sample of the liquid to be assessed (test substance, e.g. rosmarinic acid) into the mouth and after some time allowed for taste perception to spit the sample out completely. Subsequently, the panelists are asked to rinse their mouth well with water or black tea to reduce any potential carry over effects. The tasting of a sample can be repeated if required.

In a first descriptive test (qualitative assessment for sweetness) the panelists are asked to taste the quality of single samples (maximum 3 subsequent samples). The individuals of the taste panel are asked to answer the following questions with regard to the quality of taste: 1) does the sample taste sweet?. 2) is there another taste detectable (bitter, sour, salty, umami)?. 3) is there an off- or aftertaste?. 4) is there anything else remarkable about the perception of the sample?

In the next step (assessment of sweetness enhancing, e.g. fructose enhancing, features) the panelists are asked to answer questions in a pairwise comparison test to determine the enhancement of sweet taste of the test substance with fructose relative to fructose only. Again the panelists are given samples. Two samples are prepared for direct comparison regarding sweetness. One sample contains fructose in a solvent and the other sample additionally contains the test substance. Designation of the samples with A and B is randomized and is decoded after the taste procedure. The questions to be answered are: 1) does one sample taste sweeter than the other?, 2) if so, which one?, 3) are there any other differences in the taste between the two samples? The result of the taste and spit assay is a qualitative evaluation of the differences between the two samples.

In another embodiment, the sweetness and/or sweetness enhancing properties of the inventive sweetener composition, when dissolved in water, correspond to a particular degrees Brix, a well-known measurement of sugar content in an aqueous solution. In some embodiments, for example, when 5 grams of sweetener composition are dissolved in 95 grams of water, the resultant solution has a sweetness that corresponds to a degrees Brix value ranging from 1 to 1000, e.g., from 5 to 500 or from 5 to 100.

Preferably, one gram of the sweetener composition contains less calories and carbohydrates than about 1 gram of granulated sugar, e.g., less than about 0.5 grams of granulated sugar.

In another embodiment of the invention, the sweetener composition of the invention is substantially free of off-taste.

In one embodiment of the invention, the sweetener composition of the invention is liquid at ambient conditions.

In another embodiment of the invention, the sweetener composition of the invention is solid at ambient conditions.

In one embodiment of the invention, the sweetener composition of the invention comprises homogeneous particles comprising the sweetener and rosmarinic acid. Preferably, the homogeneous sweetener particles have an average particle size of between about 50 microns and about 1250 microns, e.g., between about 100 microns and about 1000 microns.

In another embodiment of the invention, the sweetener composition comprises a mixture of first particles comprising the sweetener and second particles comprising rosmarinic acid or a derivative or a stereoisomer or a salt or a hydrate thereof.

Preferably, the sweetener composition of the invention comprises from 0.0005 to 1.0 wt % of the sweetness enhancer, e.g., rosmarinic acid, based on the total weight of the sweetener composition, preferably from 0.0001 to 0.1 wt %, particularly preferred from 0.001 to 0.05 wt %.

### Methods of Making a Sweetener Composition of the Invention and Enhancing the Sweetness of a Sweetener Composition

In another aspect, the present invention relates to a method of making a sweetener composition comprising the step of admixing a sweetener with rosmarinic acid or a derivative or a stereoisomer or a salt or a hydrate thereof.

In one embodiment, the method yields a sweetener composition comprising rosmarinic acid in the form of an extract or in isolated or purified form.

In another embodiment, the sweetener composition comprises rosmarinic acid or a derivative or a stereoisomer or a salt or a hydrate thereof in a purity of greater than about 60% by weight, e.g., greater than about 70% by weight, greater than about 80% by weight, greater than about 90% by weight, greater than about 98% by weight, or greater than about 99% by weight.

In another embodiment, the inventive method further comprises the step of combining rosmarinic acid or a derivative or a stereoisomer or a salt or a hydrate thereof with at least one other ingredient chosen from bulking agents, carriers, fibers, sugar alcohols, oligosaccharides, sugars, high intensity sweeteners, nutritive sweeteners, flavoring, flavor enhancers, flavor stabilizers, acidulants, anti-caking, free-flow agents, and any combination thereof. Preferably the resultant composition comprises about 3 to about 200 mg of rosmarinic acid or a derivative or a stereoisomer or a salt or a hydrate thereof per 1 gram of the composition, e.g., about 3 to about 100 mg of rosmarinic acid or a derivative or a stereoisomer or a salt or a hydrate thereof per 1 gram of the composition, or about 5 to about 10 mg of rosmarinic acid or a derivative or a stereoisomer or a salt or a hydrate thereof per 1 gram of the composition.

In another embodiment, the invention relates to a method for enhancing the sweetness of a sweetener composition comprising a sweetener, comprising the step of adding to the sweetener rosmarinic acid or a derivative or a stereoisomer or a salt or a hydrate thereof to form an enhanced sweetener composition. Preferably, rosmarinic acid is added in amount effective to increase the sweetness of the sweetener composition to an increased sweetness level.

### Formulations

In another aspect, the present invention relates to formulations of the sweetener composition.

In these formulations, the sweetener composition of the invention may take any suitable form including, but not limited to, an amorphous solid, a crystal, a powder, a tablet, a liquid, a cube, a glace or coating, a granulated product, an encapsulated form abound to or coated on to carriers/particles, wet or dried, or combinations thereof.

For example, in one embodiment, the sweetener composition formulations can be provided in pre-portioned packets or ready-to-use formulations, which include rosmarinic acid. For example, in one embodiment, a single serving packet formulation (usually about a 1 gram portion) can provide sweetness comparable to that contained in from one to three teaspoons, preferably two teaspoons, of granulated sugar (sucrose). It is known in the art that a “teaspoon” of sucrose contains approximately 4 grams of sucrose.

In another embodiment, a volume of a ready-to-use formulation can provide sweetness comparable to the same volume of granulated sugar. Preferably, a single serving packet of the composition comprising rosmarinic acid (e.g., 1 gram) can provide sweetness comparable to about 0.9 to about 9.0 grams of granulated sugar (sucrose). In another embodiment, 1 gram of the sweetener composition contains less calories and carbohydrates than about 1 gram of granulated sugar.

As used herein, the term “about” encompasses the range of experimental error that occurs in any measurement. Unless otherwise stated, all measurement numbers are presumed to have the word “about” in front of them if the word “about” is not expressly used.

The formulation of the invention may contain further additives known to those skilled in the art. These additives include but are not limited to bulking agents, carriers, fibers, sugar alcohols, oligosaccharides, sugars, high intensity sweeteners, nutritive sweeteners, flavorings, flavor enhancers, flavor stabilizers, acidulants, anti-caking and free-flow agents. Such additives are for example described by H. Mitchell (H. Mitchell, “Sweeteners and Sugar Alternatives in Food Technology”, Backwell Publishing Ltd, 2006, which is incorporated herein by reference in its entirety).

### Tabletop Sweetener Compositions

In another aspect, the present invention relates to tabletop sweetener compositions comprising rosmarinic acid or a derivative or a stereoisomer or a salt or a hydrate thereof and to methods of manufacturing such tabletop sweetener compositions.

“Tabletop sweetener,” as used herein, refers to sweetener compositions that comprise at least one sweetener, and optionally, at least one sweetness enhancer, which can be used in the preparation of various food items and/or as an additive to food items. As one example, the tabletop sweetener may be used in the preparation of baked goods or other sweetened foods. As another example, the tabletop sweetener may be used to season, sweeten, or otherwise customize a prepared food item, e.g., beverages, fruit, or yoghurt. In a preferred aspect, the tabletop sweetener is in a crystalline, granulated, or powder form. In various aspects, the tabletop sweetener will comprise one or more sweeteners and/or one or more sweetness enhancers. In one embodiment, the tabletop sweetener may comprise the sweetness enhancer in combination with either or both a caloric sweetener and/or substantially non-caloric sweeteners. Typical examples of caloric sweeteners that may be used in tabletop sweeteners include sucrose, fructose, and glucose. Common tabletop forms of these caloric sweeteners include cane sugar, bee sugar, and the like. In recent decades, substantially non-caloric sweeteners have gained popularity. In many instances, these sweeteners can be used as substitutes for caloric sweeteners and are often referred to as “sugar substitutes.”

In many instances, sugar substitutes provide a greater sweetening effect than comparable amounts of caloric sweeteners, such as sucrose or fructose. Therefore, smaller amounts of sugar substitutes are required to achieve sweetness comparable to that of an amount of sugar. Sugar substitutes, however, typically have a taste profile that differs from sucrose or fructose. Such differences include, but are not limited to, increased astringency, bitterness, various aftertastes, delayed onset of sweetness, and different mouthfeel. Therefore, sugar substitutes are often formulated with other materials that can provide bulk and can enhance the taste profile to be more similar to that of sucrose or fructose. Thus, sugar substitutes have been formulated to create a tabletop sweetener formulation that has a bulk and a taste profile that is comparable to sucrose or fructose. Nevertheless, consumers can still distinguish the low-calorie sweetener formulations from caloric tabletop sweeteners. Therefore, if low-calorie tabletop sweeteners are to replace caloric tabletop sweeteners, formulations of low-calorie sweeteners must be continuously improved to meet consumer demand.

There is an increasing interest in such sweeteners containing natural ingredients. This interest sterns partially from increasing consumer interest in such products, but also from the rise of retail and internet stores selling natural products, and requiring suppliers of such products to certify that natural ingredients are used in any products being supplied.

Therefore, there is a need for new tabletop sweetener formulations which are low in calories (or have no calories) and that can reasonably approximate the taste profile, mouthfeel, and texture of caloric sweeteners.

Thus, in another aspect, the invention relates to a tabletop sweetener composition comprising
(a) a disaccharide carbohydrate and/or fructose;
(b) erythritol;
(c) rosmarinic acid or a derivative or a stereoisomer or a salt or a hydrate thereof; and
(d) a taste-improving amount of cellulose.

In some embodiments of the invention, the tabletop sweetener composition comprises a disaccharide carbohydrate and contains no fructose. In other embodiments, the tabletop sweetener composition comprises fructose and does not contain disaccharide carbohydrate. In other embodiments, the tabletop sweetener compositions comprise both a disaccharide carbohydrate and fructose.

As used herein, the term “disaccharide carbohydrate” refers to any sugar having two monosaccharide units. The monosaccharide units may exist as either ketones or aldehydes, and may have either a cyclic or acyclic structure. When a monosaccharide exists as a cyclic structure, the monosaccharide may exist as a hemiacetal or hemiketal, among other forms. Moreover, when a monosaccharide exists as a cyclic structure, either anomer is included within this definition. Illustrative monosaccharides include trioses, tetroses, pentoses, hexoses, heptoses, octoses, and nonoses. In forming a disaccharide, the monosaccharide units may bond to form either reducing disaccharides or non-reducing disaccharides.

As used herein, the term “erythritol” refers to a sugar alcohol well known to the skilled person. Erythritol, in either food grade or reagent grade is readily available through commercial sources.

As used herein, the term “cellulose” refers to any cellulosic material known to the skilled person. In typical embodiments, the cellulose includes polysaccharides having linear chains of at least several hundred beta-linked D-glucose units. When obtained from commercial sources, for example, the cellulose may exist as a powder. Further, in typical embodiments, the cellulose is insoluble or substantially insoluble in water; yet, in an application like tabletop sweeteners, when incorporated in such an application, it preferably will not detract substantially from the overall product dissolution. Chemically modified celluloses can be employed in the compositions of the invention provided the modifications do not result in water soluble material. The cellulose may have any particle size (or particle size distribution) that is suitable for use in a sweetener composition. For example, in some embodiments, the size of the cellulose particles may range from about 1 micron to about 400 microns, e.g., from about 3 microns to about 300 microns, from about 5 microns to about 200 microns, or from about 6 microns to about 100 microns. In some embodiments, the insoluble cellulose is a cellulose that if used in amounts exceeding 1% in an aqueous medium can lead to significant viscosity change.

In some embodiments of the invention, a “taste-improving amount” of cellulose is used. This “taste-improving amount” refers to an amount of cellulose that imparts an unexpected improvement in the taste profile of sweetener compositions of the invention. In some instances, for example, the taste improvement may be perceived as an enhancement in the sweetness of the sweetener composition or of the beverage or foodstuff containing the sweetener composition. In other instances, for example, the taste improvement may be perceived as a reduction or masking of the bitterness of the sweetener composition or of the beverage or foodstuff containing the sweetener composition. The taste improvement may also be a combination of both sweetness enhancement and bitterness reduction. In some embodiments of the sweetener compositions, the taste-improving amount of cellulose ranges from about 0.4% by weight to about 3.0% by weight, e.g. from about 0.7% by weight to about 2.0% by weight, of cellulose, based on the total weight of the sweetener composition. In some embodiments, the sweetener composition contains about 1% by weight cellulose, based on the total weight of the sweetener composition.

In one embodiment, the disaccharide carbohydrate includes, but is not limited to, disaccharides containing glucose, fructose, and galactose. In another embodiment, the disaccharide carbohydrate includes, but is not limited to, sucrose, lactose, maltose, trehalose, and isomaltulose. In another embodiment, the disaccharide carbohydrate is isomaltulose.

In a preferred embodiment of the invention, the disaccharide carbohydrate is selected from the group consisting of sucrose, lactose, maltose, trehalose, and isomaltulose.

Sweetener compositions of the invention may contain varying amounts of disaccharide carbohydrate and/or fructose, of erythritol, of rosmarinic acid and of cellulose. The desired amount of rosmarinic acid may vary depending on, among other factors, the desired use of the tabletop sweetener composition, the presence or absence of other components in the tabletop sweetener composition, the identity of any disaccharide, if present, and the presence or absence of fructose.

In some embodiments, the tabletop sweetener composition contains from about 40% by weight to about 70% by weight erythritol, based on the total weight of the sweetener composition, e.g., from about 50% by weight to about 60% by weight, from about 55% by weight to about 65% by weight, from about 57% by weight to about 63% by weight, or from about 60% by weight to about 62% by weight. In some embodiments, the sweetener composition contains about 55% by weight erythritol, based on the total weight of the sweetener composition.

In some embodiments, the tabletop sweetener composition contains from about 27% by weight to about 50% by weight disaccharide carbohydrate, based on the total weight of the tabletop sweetener composition, e.g., from about 35% by weight to about 45% by weight from about 30% by weight to about 40% by weight, from about 30% by weight to about 38% by weight, from about 32% by weight to about 36% by weight, or from about 33% by weight to about 35% by weight. In some such embodiments, the tabletop sweetener composition contains about 41% by weight of disaccharide carbohydrate, based on the total weight of the sweetener composition. In still other embodiments, the tabletop sweetener composition contains about 33-34% by weight of disaccharide carbohydrate, based on the total weight of the sweetener composition. In a preferred embodiment, the disaccharide carbohydrate is isomaltulose.

In some embodiments, the sweetener composition contains from about 0.5% by weight to about 7.0% by weight rosmarinic acid or a derivative or a stereoisomer or a salt or a hydrate thereof, based on the total weight of the sweetener composition, e.g., from about 0.7% by weight to about 5.0% by weight, or from about 1.0% by weight to about 2.5% by weight. The amount of rosmarinic acid used may in certain situations depend on the purity of the material.

In another embodiment, tabletop sweetener compositions of the invention contain (a) from about 38% by weight to about 43% by weight of isomaltulose; (b) from about 50% by weight to about 60% by weight erythritol; (c) from about 0.75% by weight to about 1.75% by weight rosmarinic acid; and (d) from about 0.5% by weight to about 1.5% by weight cellulose; based on the total weight of the tabletop sweetener composition.

In another embodiment, tabletop sweetener compositions of the invention contain (a) from about 30% by weight to about 38% by weight of isomaltulose; (b) from about 55% by weight to about 65% by weight erythritol; (c) from about 0.75% by weight to about 1.75% by weight rosmarinic acid; and (d) from about 0.5% by weight to about 1.5% by weight cellulose; based on the total weight of the tabletop sweetener composition.

Tabletop sweetener compositions of the invention may also contain amounts of other ingredients in addition to disaccharide and/or fructose, erythritol, rosmarinic acid and cellulose. Such additional ingredients include, but are not limited to, sweetness modifiers, mouthfeel enhancers, flavorings (e.g., vanilla flavoring), and the like. Honey and/or evaporated cane juice may be used in place of or in combination with erythritol. Natural flavors and other ingredients are preferred when the product is to be labeled as “all-natural.”

In another embodiment, the tabletop sweetener composition comprises less than about 2% by weight of a sweetness modifier, e.g., less than about 0.5% by weight. In terms of ranges, the tabletop sweetener composition may, for example, comprise between about 0.01% by weight and about 2% by weight sweetness modifier, in particular between about 0.1% by weight and about 1.5% by weight sweetness modifier.

In another embodiment, the tabletop sweetener composition comprises less than about 1% by weight of a mouthfeel enhancer, e.g., less than about 0.5% by weight. In terms of ranges, the tabletop sweetener composition may, for example, comprise between about 0.01% by weight and about 1% by weight mouthfeel enhancer, in particular between about 0.1% by weight and about 0.5% by weight mouthfeel enhancer.

In another embodiment, the tabletop sweetener composition comprises less than about 1% by weight of a flavoring, e.g., less than about 0.5% by weight. In terms of ranges, the tabletop sweetener composition may, for example, comprise between about 0.01% by weight and about 1% by weight flavoring, in particular between about 0.1% by weight and about 0.5% by weight flavoring.

In some embodiments, sweetener compositions of the invention provide at least one, if not more than one, of the following desirable characteristics: (a) fewer calories per gram than standard table sugar; (b) fewer calories than an amount of standard table sugar perceived as providing comparable sweetness; and (c) lower glycemic index than that of standard table sugar. In some embodiments, the sweetener composition has less than about 5 calories/gram, or less than about 3 calories/gram, or less than about 1 calorie/gram. As used herein, the term “calorie” refers to the unit of energy commonly appearing on the packaging of food and/or beverage items sold in the United States. The term, as such, does not refer to 1 cal. of energy, but rather corresponds to approximately 1 kcal. of energy. In a typical tabletop sweetener application, for example, the sweetener composition can be packaged in a form where it provides a similar sweetness to about 8 grams of sucrose while providing less than about 5 calories.

In another embodiment, tabletop sweetener compositions of the invention contain a plurality of sweetener particles, wherein such particles contain one or more of the ingredients present in the tabletop sweetener composition. In some embodiments, the tabletop sweetener composition substantially comprises sweetener particles. In such embodiments, the tabletop sweetener composition contains at least about 80% by weight sweetener particles, or at least about 85% by weight sweetener particles, or at least about 90% by weight sweetener particles, based on the total weight of the tabletop sweetener composition.

Sweetener particles, when present in the tabletop sweetener composition, can have any size suitable for use of the composition as a sweetener. In some embodiments, the average size of the sweetener particles is between about 50 microns and about 1250 microns, e.g., between about 100 microns and about 1000 microns. Screening to eliminate particles of undesired sizes can be carried out during the manufacturing process. Thus, in some embodiments, the particle sizes, after screening to eliminate undesired large particles which may be as large as 1500 μm, may vary up to about 16 mesh, e.g. up to about 14 mesh, or up to about 12 mesh, based on the standard United States sieve scale. Further, smaller particle sizes, e.g., about 50 mesh, 100 mesh, or 150 mesh, or particles having sizes less than about 1 μm, e.g., less than about 0.5 μm, may be present with the larger particles. Screening to eliminate particles having sizes less than, for example, about 100 mesh or 150 mesh can be carried out if desired.

Sweetener particles in the tabletop sweetener composition may or may not have uniform composition. Preferably, the tabletop sweetener compositions of the invention comprise rosmarinic acid and an effective amount of cellulose where the composition is a mixture of particles. More specifically, the mixture comprises (a) particles having an erythritol core and (b) particles having a disaccharide core and rosmarinic acid and the cellulose, as well as other components, are predominantly coated on the particles. These coatings on the cores can be either a continuous phase or a discontinuous phase, i.e., where the different coating components form discrete regions in the core coatings.

Thus, in another aspect, the invention relates to a tabletop sweetener composition comprising:
(a) a plurality of first sweetener particles, where the first sweetener particles have (i) an erythritol core, (ii) a first erythritol core-coating layer comprising rosmarinic acid or a derivative or a stereoisomer or a salt or a hydrate thereof and cellulose, and (iii) a second erythritol core-coating layer comprising a disaccharide carbohydrate, where the second erythritol core-coating layer lies outside of the first erythritol core-coating layer; and
(b) a plurality of second sweetener particles, where the second sweetener particle has (i) a disaccharide core, (ii) a first disaccharide core-coating layer comprising rosmarinic acid or a derivative or a stereoisomer or a salt or a hydrate thereof and cellulose, and (iii) a second disaccharide core-coating layer comprising a disaccharide carbohydrate, where the second disaccharide core-coating layer lies outside of the first disaccharide core-coating layer.

In such embodiments, the core-coating layers may or may not have uniform compositions, and may or may not substantially coat the underlying core or layer. In some embodiments, the first erythritol core-coating layer and/or the first disaccharide core-coating layer have discrete regions of rosmarinic acid and cellulose.

In another embodiment, the tabletop sweetener composition comprises a mixture of the plurality of first sweetener particles and the plurality of second sweetener particles.

In another embodiment of the tabletop sweetener composition, the disaccharide core contains isomaltulose. Further, in some embodiments, the second erythritol core-coating layer and/or the second disaccharide core-coating layer contain isomaltulose.

These tabletop sweetener compositions may also contain flavorings (e.g., vanilla flavor), mouthfeel enhancers, and/or sweetness modifiers. When one or more of these are present, the first erythritol core-coating layer and/or the disaccharide core-coating layer may contain one or more of flavorings (e.g., vanilla flavor), mouthfeel enhancers, and/or sweetness modifiers. Moreover, as used herein, the term “layer” may or may not refer to a material that entirely surrounds the underlying material. Thus, a “layer” may be non-uniform in composition and may provide only discontinuous coverage of the underlying material. Moreover, when one layer covers another, the boundary between the layers may or may not be discrete; thus, the boundary between layers may be continuous or semi-continuous.

In the sweetener compositions described herein, the tabletop sweetener compositions may or may not contain other particles in addition to the plurality of first sweetener particles and the plurality of second sweetener particles. The first sweetener particles and the second sweetener particles may have any particle size that is suitable for use of the composition as a sweetener.

In some embodiments, the average size of the first sweetener particles and second sweetener particles is between about 50 microns and about 1250 microns, e.g., between about 100 microns and about 1000 microns. In some embodiments, the particle sizes of the first sweetener particles and the second sweetener particles, after screening to eliminate undesired large particles which may be as large as 1500 μm, will vary up to about 16 mesh, e.g., up to about 14 mesh, or up to about 12 mesh, based on the standard United States sieve scale. Further, smaller particle sizes, e.g., about 50 mesh, 100 mesh, or 150 mesh, or particles having sizes less than about 1 μm, e.g., less than about 0.5 μm, will be present with the larger particles. In some embodiments, the tabletop sweetener composition comprises a mixture of the plurality of first sweetener particles and the second sweetener particles. Such a mixture may or may not contain other types of particles.

The layers in the sweetener composition particles are generally not distinct, i.e., there is no clear demarcation between the first layer and the second layer. For example, in one embodiment, the first layer contains rosmarinic acid, optional flavoring components, etc., all encased in disaccharide; and the second layer will be predominantly disaccharide with some of the other components. The relative quantities of the various components in the layers, and whether there are layers in the particles, can be modified as necessary by adjusting when during the manufacturing process the components are added.

In some embodiments of the invention, the tabletop sweetener composition comprises rosmarinic acid and a taste-improving amount of cellulose as a mixture, where the mixture comprises (a) particles having an erythritol core and (b) particles having a disaccharide core. In some such embodiments, the disaccharide core comprises isomaltulose. Further, in some such embodiments, the erythritol core and/or the disaccharide core further comprise coating layers having discrete regions of rosmarinic acid and cellulose. When such coating layers are present, the coating layers may or may not substantially coat the underlying core material. These particles may have any particle size that is suitable for use of the composition as a sweetener. In some embodiments, the average size of the particles is between about 50 microns and about 1250 microns, e.g., between about 100 microns and about 1000 microns. In some embodiments, the particle sizes of the particles range from about 16 mesh, or from about 14 mesh, or from about 12 mesh to about 100 mesh, based on the standard United States sieve scale.

Sweetener compositions of the invention may have any dissolution rate in water that is suitable for their use as sweeteners. In some embodiments, the sweetener composition can have a dissolution rate in water at 10° C. of between about 100 seconds and about 200 seconds, e.g., between about 125 seconds and about 175 seconds, or between about 140 seconds and 160 seconds, based on the dissolution of about 2 grams of the sweetener composition in 240 ml of water. In some embodiments, the sweetener composition can have a dissolution rate in water at 45° C. of between about 50 seconds and about 150 seconds, e.g., between about 75 seconds and about 125 seconds, or between about 85 seconds and 110 seconds, based on the dissolution of about 2 grams of the sweetener composition in 240 ml of water. In some embodiments, the dissolution rate of the sweetener composition is about 150 seconds at 10° C. and about 96 seconds at 45° C., based on the dissolution of about 2 grams of the sweetener composition in 240 mL, of stirred water.

In another embodiment, the invention relates to single-serving packets.

In another embodiment, the invention relates to tabletop sweeteners comprising rosmarinic acid or a derivative or a stereoisomer a salt or a hydrate thereof. Preferably, the tabletop sweetener is a tabletop tablet sweeteners, tabletop “spoon to spoon” sweeteners, tabletop “sachet” sweeteners, tabletop liquid sweeteners. The tabletop sweeteners, in addition to the rosmarinic acid component, may contain further substances including but not limited to aspartame, binding agents, citric acid, cyclamate, lactose, carboxymethylcellulose, leucin, maltodextrin, isomalt, NHDC, potassium hydroxide (in aqueous solution), dextrose, other bulking agents, sucralose, sodium cyclamate, sodium hydrogen carbonate, sodium saccharin and tartric acid.

In another embodiment, the invention relates to a package containing a predetermined amount, e.g., from about 0.8 grams to about 3.5 grams, of a solid tabletop sweetener composition, where the predetermined amount of the solid tabletop sweetener composition has a sweetness equivalent to about four times (by weight) the predetermined amount of sucrose, and where the solid sweetener composition comprises;
(a) from about 38% by weight to about 43% by weight of isomaltulose;
(b) from about 50% by weight to about 60% by weight erythritol;
(c) from about 0.75% by weight to about 1.75% by weight of rosmarinic acid; and
(d) from about 0.5% by weight to about 1.5% by weight cellulose.

In another embodiment, the invention relates to a package containing a predetermined amount, e.g., from about 0.8 grams to about 3.5 grams, of a solid sweetener composition, where the predetermined amount of the solid sweetener composition has a sweetness equivalent to about four times (by weight) the predetermined amount of sucrose, and where the solid sweetener composition comprises:
(a) from about 30% by weight to about 38% by weight of isomaltulose;
(b) from about 55% by weight to about 65% by weight erythritol;
(c) from about 0.75% by weight to about 1.75% by weight of rosmarinic acid; and
(d) from about 0.5% by weight to about 1.5% by weight cellulose.

In the tabletop sweetener packages containing a predetermined amount of the solid tabletop sweetener composition, the predetermined amount may be about 1 gram and may have a sweetness equivalent to about 4 grams of sucrose, or the predetermined amount may be about 2 grams and may have a sweetness equivalent to about 8 grams of sucrose.

The tabletop sweetener packages may contain a formulation for a ready-to-use sweetener or tabletop sweetener compositions in the form of cubes for use, for example, in restaurants. The cubes weigh approximately 8 grams and are of equivalent size to a standard cube of granulate sugar, which is 2.2 cm×2.2 cm×1 cm.

Tabletop sweetener compositions of the invention may have any bulk density that is suitable for their use as sweeteners. In some embodiments, the bulk density of the sweetener composition ranges from about 0.5 g/cm³ to about 1.0 g/cm³, or from about 0.7 g/cm³ to about 0.8 g/cm³. In some embodiments, the bulk density of the sweetener composition is about 0.76 g/cm³.

In another aspect, the invention relates to a method of making a tabletop sweetener composition, comprising the steps of:
(a) providing a fluid-bed coating apparatus;
(b) introducing dry disaccharide carbohydrate and/or fructose, dry erythritol, dry rosmarinic acid and dry cellulose powder to the fluid-bed coating apparatus;
(c) charging a substantially all of the dry ingredients in the fluid-bed coating apparatus;
(d) spraying a coating solution into the fluid-bed coating apparatus to form coated sweetener particles; and
(e) drying the coated sweetener particles.

In another aspect, the invention relates to a method of making a tabletop sweetener composition, comprising the steps of:
(a) providing a fluid-bed coating apparatus;
(b) introducing dry disaccharide carbohydrate and/or fructose, dry erythritol and dry rosmarinic acid to the fluid-bed coating apparatus;
(c) charging a substantially all of the dry ingredients in the fluid-bed coating apparatus;
(d) spraying a coating solution into the fluid-bed coating apparatus to form coated sweetener particles;
(e) during the spraying step, introducing dry cellulose powder to the fluid-bed coating apparatus; and
(f) drying the coated sweetener particles.

The methods of the invention described above may be carried out as described in WO 2010/025158 A1, which is incorporated herein by reference in its entirety.

### Consumables Containing a Sweetener Composition or a Tabletop Sweetener Composition of the Invention

The inventive sweetener compositions comprising rosmarinic acid and the inventive tabletop sweetener compositions described above can be added to any consumable products including but not limited to consumables, dental products, cosmetic products, pharmaceutical products and animal feed or animal food.

Thus, in another embodiment, the invention relates to a consumable comprising
(a) a consumable product; and
(b) a sweetener composition of the invention as defined above or a tabletop sweetener composition of the invention as defined above.

Preferably, the sweetener composition of the invention and the tabletop sweetener composition of the invention are present in the consumable in an amount effective to increase a sweetness level of the consumable.

Preferably, in the consumable of the invention rosmarinic acid or a derivative or a stereoisomer or a salt or a hydrate thereof is present in a concentration from 0.1 wppm to 100 wppm, in particular 0.2 wppm to 50 wppm, particularly preferred from 0.5 wppm to 10 wppm.

The following consumable products and their ingredients are suitable for use in embodiments of the present invention.

Consumable products include all food products, including but not limited to cereal products, rice products, tapioca products, sago products, baker's products, biscuit products, pastry products, bread products, confectionery products, desert products, gums, chewing gums, chocolates, ices, honey products, treacle products, yeast products, baking-powder, salt and spice products, savory products, mustard products, vinegar products, sauces (condiments), tobacco products, cigars, cigarettes, processed foods, cooked fruits and vegetable products, meat and meat products, jellies, jams, fruit sauces, egg products, milk and dairy products, yoghurts, cheese products, butter and butter substitute products, milk substitute products, soy products, edible oils and fat products, medicaments, beverages, carbonated beverages, alcoholic drinks, beers, soft drinks, mineral and aerated waters and other non-alcoholic drinks, fruit drinks, fruit juices, coffee, artificial coffee, tea, cacoa, including forms requiring reconstitution, food extracts, plant extracts, meat extracts, condiments, sweeteners, nutraceuticals, gelatins, pharmaceutical and non-pharmaceutical gums, tablets, lozenges, drops, emulsions, elixirs, syrups and other preparations for making beverages, and combinations thereof.

Consumable products include without limitation, water-based consumables, solid dry consumables, dairy products, dairy-derived products and dairy-alternative products.

In one embodiment, the consumable product is a water-based consumable including but not limited to beverage, water, aqueous beverage, enhanced/slightly sweetened water drink, mineral water, carbonated beverage, non-carbonated beverage, carbonated water, still water, soft drink, non-alcoholic drink, alcoholic drink, beer, wine, liquor, fruit drink, juice, fruit juice, vegetable juice, broth drink, coffee, tea, black tea, green tea, oolong tea, herbal tea, cacoa (water-based), tea-based drink, coffee-based drinks, cacao-based drink, syrup, frozen fruit, frozen fruit juice, water-based ice, fruit ice, sorbet, dressing, salad dressing, sauce, soup, and beverage botanical materials (whole or ground), or instant powder for reconstitution (coffee beans, ground coffee, instant coffee, cacao beans, cacao powder, instant cacao, tea leaves, instant tea powder).

In another embodiment, the consumable product is a solid dry consumable including but not limited to cereals, baked food products, biscuits, bread, breakfast cereal, cereal bar, energy bars/nutritional bars, granola, cakes, rice cakes, cookies, crackers, donuts, muffins, pastries, confectioneries, chewing gum, chocolate, fondant, hard candy, marshmallow, pressed tablets, snack foods, botanical materials (whole or ground), and instant powders for reconstitution.

In another embodiment, the consumable product is selected from the group of a dairy product, dairy-derived product and dairy-alternative product, including but not limited to milk, fluid milk, cultured milk product, cultured and noncultured dairy-based drink, cultured milk product cultured with lactobacillus, yoghurt, yoghurt-based beverage, smoothy, lassi, milk shake, acidified milk, acidified milk beverage, butter milk, kefir, milk-based beverages, milk/juice blend, fermented milk beverage, icecream, dessert, sour cream, dip, salad dressing, cottage cheese, frozen yoghurt, soy milk, rice milk, soy drink, and rice milk drink.

Preferably, the consumable product is a carbonated drink and the invention relates to a carbonated drink comprising a sweetener composition of the invention or a tabletop sweetener composition of the invention.

Preferably, the consumable product is a non-carbonated drink and the invention relates to a non-carbonated drink comprising a sweetener composition of the invention or a tabletop sweetener composition of the invention.

In another embodiment, the consumable products are alcoholic beverages and the invention relates to alcoholic beverages comprising a sweetener composition of the invention or a tabletop sweetener composition of the invention, preferably to shandy beer, wine cooler, wildberry cooler (5% alcohol), strawberry daiquiri cooler (5% alcohol), margarita cooler (5% alcohol) and raspberry cooler. In addition, the alcoholic beverages may contain further substances including but not limited to aspartame, beer, color, citric acid monohydrate, cyclamate, fruit juice (e.g. peach, pineapple), lemon flavor, margarita flavor, rum flavor, sucrose, vodka, wildberry flavor, wine and water.

In another embodiment, the consumable products are fruit juices and the invention relates to fruit juices comprising a sweetener composition of the invention or a tabletop sweetener composition of the invention, preferably to functional fruit drinks (30% fruit juice content), fruit nectar, fruit juice drinks, no sugar added fruit beverages (5% juice, kiwi-strawberry flavored) and ruby red grapefruit and tangerine juice drinks (from concentrate). In addition, the fruit juices may contain further substances including but not limited to aspartame, anthocyane, ascorbic acid, carotinoids, citric acid (anhydrous), cyclamate, luteine, fruit concentrate, fruit juice concentrate, flavor, fruit, grapefruit pulp cells, grapefruit flavor, kiwi juice concentrate, kiwi-strawberry flavor, malic acid, pectin, ruby red grapefruit concentrate, strawberry juice concentrate, tangerine juice concentrate, tangerine flavor, vegetable extract (grape, pumpkin, carrot, aroma, blackcurrant, hibiscus etc.) and water.

In another embodiment, the consumable product is ice tea and the invention relates to ice tea comprising a sweetener composition of the invention or a tabletop sweetener composition of the invention, preferably to ice tea and sugar free ice tea mix. In addition, the ice tea may contain further substances including but not limited to base with lemon flavor, base with tea component, citric acid, cyclamate, flavor, instant tea, lemon juice, maltodextrin, malic acid (powdered), saccharin, sucralose, sucrose, tea and tea extract.

In another embodiment, the consumable products are soft drinks without sugar and the invention relates to soft drinks without sugar comprising a sweetener composition of the invention or a tabletop sweetener composition of the invention, preferably to soft drinks Cola flavored, fruit nectars, fruit juice drinks, soft drinks, soft drinks lemon lime flavored, diet sparkling waters (peach flavored) and sugar free liquid beverages. In addition, the soft drinks without sugar may contain further substances including but not limited to alitame, aspartame, bilberry flavor, citric acid monohydrate, caffeine, cola flavor, cyclamate, peach flavor, potassium citrate, sodium-cyclamate, grape color, grape flavor, sodium benzoate, sodium citrate, sodium-saccharin, ethylmaltol, flavor, lemon-lime flavor, maltol, neotame, NHDC, passion fruit flavor, pectin, phosphoric acid (85%), saccharin, sucralose and water.

In another embodiment, the consumable products are soft drinks with sugar and the invention relates to soft drinks with sugar comprising a sweetener composition of the invention or a tabletop sweetener composition of the invention. In addition, the soft drinks with sugar may contain further substances including but not limited to aspartame, citric acid monohydrate, concentrate, caffeine, flavor, fructose, glucose, glucose syrup, high fructose con syrup (HFCS, total solids: approx. 77%, fructose: 55% and glucose: 41%), neotame, orangeade base, phosphoric acid (85%), sodium-cyclamate, sucrose and water.

In another embodiment, the consumable products are sports drinks and the invention relates to sports drinks comprising a sweetener composition of the invention or a tabletop sweetener composition of the invention, preferably to isotonic energy drinks and whey drinks. In addition, the sports drinks may contain further substances including but not limited to aspartame, ascorbic acid, concentrate, caffeine, citric acid, flavor, glucose (anhydrous), herbs, minerals, neohesperidine-DC, natural extracts, sucralose, taurine, vitamins, water and whey powder.

In another embodiment, the consumable products are dry powder beverages and the invention relates to dry powder beverages comprising a sweetener composition of the invention or a tabletop sweetener composition of the invention. In addition, the dry powder beverages may contain further substances including but not limited to aspartame, apple flavor, ascorbic acid, citric acid, cherry flavor, malic acid, orange flavor, raspberry flavor, sodium chloride, trisodium citrate, tricalcium phosphate, titanium dioxide and xantham gum.

In another embodiment, the consumable product is ice coffee and the invention relates to ice coffee comprising a sweetener composition of the invention or a tabletop sweetener composition of the invention. In addition, the ice coffee may contain further substances including but not limited to aspartame, coffee extract, ethylmaltol, flavor and neohesperidine-DC.

In another embodiment, the consumable products are instant cake fillings and the invention relates to instant cake fillings comprising a sweetener composition of the invention or a tabletop sweetener composition of the invention. In addition, the cake fillings may contain further substances including but not limited to milk, isomalt, oligofructose, modified starch, flavors and colors. In another embodiment, the cake fillings may contain further substances including but not limited to raspberries, strawberry puree, polydextrose, isomalt, sorbitol, glycerin, fructose, pectin, locust bean gum, calcium chloride, sodium bicarbonate, citric acid and water.

In another embodiment, the consumable products are biscuits and the invention relates to biscuits comprising a sweetener composition of the invention or a tabletop sweetener composition of the invention. In addition, the biscuits may contain further substances including but not limited to isomalt, powdered isomalt, granulated isomalt, polydextrose, shortening, water, sodium bicarbonate, ammonium bicarbonate, skimmed milk powder, salt, flour, cake flour, flavor, inulin, wheat fiber, shortening, ground raisins, raisin paste, oatrim gel, liquid whole eggs, liquid egg whites, powdered egg whites, egg yolk, vanilla, butter flavor, vanilla flavor, chocolate flavor, cocoa, high fructose corn syrup (HFCS), methocel, baking soda, cinnamon, sodium acid pyrophosphate, margarine spread, margarine, emulsifier, molasses, mono- and diglycerides, powdered cellulose, ground hazelnuts, hazelnuts, sorbitol, oat fiber, vital wheat gluten, chocolate chips, maltitol and fat replacer.

In another embodiment, the consumable products are cakes and the invention relates to cakes comprising a sweetener composition of the invention or a tabletop sweetener composition of the invention. In addition, the cakes may contain further substances including but not limited to baking powder, baking soda, blueberry flavor, all purpose flour, cake flour, diacetyl 4×, dextrose, dried butter flavor, flour, cellulose, crystalline fructose, emulsifier, egg whites solid, eggs, dried egg white, fat replacers such as inulin, isomalt, lecithin, milk, non fat dry milk, modified starch, maltodextrin, oligofructose, potato fiber, polydextrose, salt, shortening, crystalline sorbitol, sodium aluminium phosphate, sucrose, butter flavor, chocolate flavor, (dried) vanilla flavor, water, wheat fiber, xanthan gum and vegetable oil.

In another embodiment, the consumable products are bakery products other than cakes and the invention relates to bakery products other than cakes comprising a sweetener composition of the invention or a tabletop sweetener composition of the invention, preferably to light hot fudge toppings, torteletts with strawberry fillings, sugar free maple flavored syrups, sugar free dark chocolate coatings, sugar free chocolate syrups, reduced-calorie chocolate syrups, no sugar added caramel corn, light chocolate frostings, light caramel toppings and light apple tart. In addition, the bakery products may contain further substances including but not limited to aspartame, baking powder, baking soda, disodium phosphate, maple flavor, caramel flavor, caramel color, flour, carrageenan, cocoa powder, cocoa butter, (microcrystalline) cellulose, citric acid, calcium chloride, crystalline fructose, fructose, chocolate liquor, eggs, dried egg white, fudge flavor, isomalt, lecithin, non fat dry milk, hydrogenated starch hydrolysate, margarine, modified starch, maltisorb, maltodextrin, nonfat dry milk, oligofructose, potassium sorbate, pectin, potato fiber, hydrogenated potato starch, polydextrose, skimmed milk powder, shortening, (crystalline) sorbitol, sodium benzoate, salt, sorbitol, (powdered) sucrose, butter flavor, chocolate flavor, vanillin, (dried) vanilla flavor, water, wheat fiber and xanthan gum.

In another embodiment, the consumable products are confectionary products and the invention relates to confectionary products comprising a sweetener composition of the invention or a tabletop sweetener composition of the invention, preferably to sugar free hard candy, reduced calorie no sugar added hard candy, hard candies, sugar free milk chocolate, milk chocolate, sugar free gummy bear, reduced calorie no sugar added gummy bear, sugar free dark chocolate, reduced calorie no sugar added hard candy, reduced calorie no sugar added caramel, reduced calorie caramel, raspberry jellies, jellies, plain bitter chocolate, toffees, sugar-free rice cake, sugar free peppermint breathmint, sugar free orange chewy candy and sugar free jelly beans. In addition, the confectionary products may contain further substances including but not limited to butter fat, (caramel) flavor, citric acid (monohydrate), cherry flavor, chocolate liquor, cocoa butter, cocoa mass, color, corn syrup, (microcrystalline) cellulose, disodium phosphate, egg Albumen-dried, evaporated milk, gelatin, glycerol monostearate, gum Arabic, hydrogenated starch hydrolysate, hydrogenated fat, isomalt, lecithin, lemon oil, maltitol (syrup, powdered and/or granular), medium-grain brown rice, Korean black rice, maltol, mocha paste, neohesperidine-DC, orange flavor, pectin, peppermint flavor, polydextrose, raspberry puree, raspberry puree, salt, sodium caseinate, sorbitol (powder), starch, sucrose, vanillin, vegetable fat, whole milk powder, skimmed milk powder, water and xylitol.

In another embodiment, the consumable products are delicacies sauces and the invention relates to delicacies sauces comprising a sweetener composition of the invention or a tabletop sweetener composition of the invention, preferably to sugar reduced ketchup with sugar, no added sugar Ketchup and tomato ketchup. In addition, the delicacies sauces may contain further substances including but not limited to citric acid, modified starch, mustard, onions, pectin, polydextrose, saccharine sodium, salt, spices, sucralose, sugar, thickener, tomato concentrate and vinegar.

In another embodiment, the consumable products are cereals and the invention relates to cereals comprising a sweetener composition of the invention or a tabletop sweetener composition of the invention.

In another embodiment, the consumable products are dairy products and the invention relates to dairy products comprising a sweetener composition of the invention or a tabletop sweetener composition of the invention, preferably to fruit quarks, whipped creams, (vanilla flavored skim) milk drinks and yoghurt drinks. In addition, the dairy products may contain further substances including but not limited to aspartame, blackcurrant, blackberry, blueberry, cyclamate, flavor, fruit preparation, fruit juice concentrate, fructose, gelatin, inulin, oat, orange juice, pectin, raspberry, redcurrant, stabilizer, wheat fiber, water, quark, yoghurt, whipped cream and whey.

In another embodiment, the consumable products are desserts and the invention relates to desserts comprising a sweetener composition of the invention or a tabletop sweetener composition of the invention, preferably to jellied red fruit cocktails, strawberry sorbet, (fat-free/sugar-free) instant pudding chocolate flavors, instant desserts, vanilla puddings, vanilla pudding—powder mixtures and litchee gelees. In addition, the desserts may contain further substances including but not limited to aspartame, blackberries, brandy, citric acid, caramel color, color, cyclamate, chocolate flavor, cocoa powder, corn starch, disodium phosphate, emulsifier, fructose, granulated sugar, white soft sugar, agar powder, ingestible dextrin, mannan, maltodextrin, mono- and diglycerides, inulin, polydextrose, lemon juice, maltodextrin, milk modified food starch, polydextrose, raspberries, redcurrant juice, salt, soy lecithin, strawberries, strawberry puree, tetrasodium pyrophosphate, litchee flavor, vanilla flavor, wheat starch, water and xanthan gum.

In another embodiment, the consumable product is water-based ice and the invention relates to water-based ice comprising a sweetener composition of the invention or a tabletop sweetener composition of the invention, preferably to “ice-pops” and no sugar added strawberry sorbet. In addition, the water-based ice may contain further substances including but not limited to aspartame, citric acid, color, fruit concentrate, flavor, isomalt, lemon juice, polydextrose, strawberry puree, sorbitol, thickener and water.

In another embodiment, the consumable product is ice cream and the invention relates to ice cream comprising a sweetener composition of the invention or a tabletop sweetener composition of the invention. In addition, the ice-cream may contain further substances including but not limited to color, emulsifier, flavor, isomalt, milk fat, fat replacer, skim milk powder, palatinit, polydextrose and lactitol.

In another embodiment, the consumable product is yoghurt and the invention relates to yoghurt comprising a sweetener composition of the invention or a tabletop sweetener composition of the invention. In addition, the yoghurt may contain further substances including but not limited to alitame, aspartame, citric aid monohydrate, tri-calcium-dicitrate, cyclamate, Na-cyclamate, fruit preparation, high fructose corn syrup (HFCS), inulin, fructose, fructose syrup, oligofructose syrup, neohesperidine-DC, pectin-solution, saccharin, starch, strawberries, strawberry-flavor, sucralose, water and (low fat, preferably between 0.1% to 1.5% fat) yoghurt.

In another embodiment, the consumable products are jams and the invention relates to jams comprising a sweetener composition of the invention or a tabletop sweetener composition of the invention. In addition, the jams may contain further substances including but not limited to gelling agent, isomalt, maltitol, pectin, sorbitol and strawberries.

In another embodiment, the consumable product is chewing-gum and the invention relates to chewing-gum comprising a sweetener composition of the invention or a tabletop sweetener composition of the invention.

The amount of rosmarinic acid in the consumable of the invention is dependent on the concentration of the natural and or artificial sweeteners contained therein as well as on the presence of further auxiliary substances such as carbon dioxide, flavors (e.g. spices, natural extract or oils), colors, acidulants (e.g. phosphoric acid and citric acid), preservatives, potassium, sodium. The amount of rosmarinic acid or a derivative or a stereoisomer or a salt or a hydrate thereof may generally be between 0.01 mg and 10 g of rosmarinic acid or a derivative or a stereoisomer or a salt or a hydrate thereof per kg of the entire finished consumable, e.g., between 0.01 and 1 g of rosmarinic acid or a derivative or a stereoisomer or a salt or a hydrate thereof per kg, between 0.1 mg and 500 mg of rosmarinic acid or a derivative or a stereoisomer or a salt or a hydrate thereof per kg, or between 0.1 mg and 50 mg of rosmarinic acid or a derivative or a stereoisomer or a salt or a hydrate thereof per kg.

In another embodiment, the consumable product is a dental product and the invention relates to a dental product comprising a sweetener composition of the invention or a tabletop sweetener composition of the invention. Dental products include, but are not limited to toothpaste, dental floss, mouthwash, denture adhesive, enamel whitener, fluoride treatments and oral care gels. These products are also known in the art.

In a preferred embodiment the consumable product is toothpaste and the invention relates to toothpaste comprising a sweetener composition of the invention or a tabletop sweetener composition of the invention. In addition, the toothpaste may contain further substances including but not limited to abrasive silica, dicalcium phosphate dehydrate, hydrated silica (thickener), ethyl alcohol, peppermint flavor, mint flavor, potassium sorbate, sodium lauryl sulphate, sodium carboxymethylcellulose, sodium monofluorophosphate, sodium monofluorophosphate, sorbitol solution, tetrasodium phosphate and titanium dioxide.

In another embodiment, the consumable product is a cosmetic product and the invention relates to a cosmetic product comprising a sweetener composition of the invention or a tabletop sweetener composition of the invention. Cosmetic products include but are not limited to lipstick, lip balm, lip gloss, and petroleum jelly. These products are also known in the art.

In another embodiment, the consumable product is a pharmaceutical product and the invention relates to a pharmaceutical product comprising a sweetener composition of the invention or a tabletop sweetener composition of the invention. Pharmaceutical products include but are not limited to over-the-counter and prescription drugs including but not limited to non-tobacco snuff, tobacco substitutes, chewable medications, cough syrups, throat sprays, throat lozenges, cough drops, antibacterial products, pill coatings, gel caplets, soluble fiber preparations, antacids, tablet cores, rapidly absorbed liquid compositions, stable foam compositions, rapidly disintegrating pharmaceutical dosage forms, beverage concentrates for medicinal purposes, aqueous pharmaceutical suspensions, liquid concentrate compositions, and stabilized sorbic acid solutions, phosphate buffers, saline solutions, emulsion, non-aqueous pharmaceutical solvents, aqueous pharmaceutical carriers, solid pharmaceutical carrier, and pharmaceutical preservatives/additives (antimicrobials, antioxidants, chelating agents, inert gases, flavoring agents, coloring agents).

In another embodiment, the consumable product is animal feed or animal food and the invention relates to animal feed or animal food comprising a sweetener composition of the invention or a tabletop sweetener composition of the invention.

In another aspect, the invention relates to a method of providing a sweetened consumable of the invention as defined above by admixing a sweetener composition of the invention as defined above or a tabletop sweetener composition of the invention as defined above to a consumable product.

In another aspect, the invention relates to a method of enhancing the taste sensations associated with flavor ingredients by admixing a sweetener composition of the invention as defined above or a tabletop sweetener composition as defined above with one or more flavor ingredients to provide a flavor-enhanced composition or consumable.

The invention, in another embodiment, relates to a method of increasing a sweetness level of a consumable having an initial sweetness level comprising the step of adding to the consumable rosmarinic acid or a derivative or a stereoisomer or a salt or a hydrate thereof in an amount effective to increase the sweetness lever of the consumable to a final sweetness level.

Preferably, the compound of the present invention may be used in a comestible composition in a concentration range of from 0.001 wppm to 1 wt. %, more in particular in a range of from 0.01 wppm to 0.1 wt. %, even more in particular in a range of from 0.01 wppm to 0.01 wt. %, even more in particular in a range of from 0.1 wppm to 0.001 wt. %, even more in particular in a range of from 0.01 wppm to 0.001 wt. %, and most particular in a range of from 0.1 wppm to 0.001 wt. %. As used herein, the abbreviation “wppm” refers to weight parts per million.

### Preferred Combinations of Sweeteners and Sweetness Enhancers

Rosmarinic acid or a derivative or a stereoisomer or a salt or a hydrate thereof may also be combined with one or more, e.g., two or more or three or more, sweeteners (e.g. one or more sugar(s)) and/or sweetness enhancers in addition to the inventive compound. In one embodiment, these combinations may be utilized in comestible goods, e.g., to sweeten the respective comestible good.

As used herein, the abbreviation “HSH” refers to hydrogenated starch hydrolyzates. The abbreviation “NHDC” refers to neohesperidine dihydrochalcone”. A preferred Acesulfame K commercial product is Sunett®, from Nutrinova.

In some exemplary embodiments, rosmarinic acid or a derivative or a stereoisomer or a salt or a hydrate thereof may be combined with one or more sweetener(s), e.g. sugar(s), and/or sweetness enhancer(s), as shown in Table 1 below. The combinations in this listing are merely exemplary and are not meant to limit the scope of the invention.

TABLE 1
Preferred Combinations of Sweeteners - General Overview

| | Additive 2 | Additive 3 | Additive 4 | Additive 5 |
|---|---|---|---|---|
| Additive 1 | (opt.) | (opt.) | (opt.) | (opt.) |
| acesulfam K | | | | |
| alitame | | | | |
| aspartame | | | | |
| cyclamate | | | | |
| saccharine | | | | |
| neotame | | | | |
| sucrose | | | | |
| sucralose | | | | |
| fructose | | | | |
| isomalt | | | | |
| polydextrose | | | | |
| oligofructose | | | | |
| sorbitol | | | | |
| HSH | | | | |
| maltitol | | | | |
| alitame | fructose | | | |
| aspartame | fructose | | | |
| aspartame | sucrose | | | |
| aspartame | sucrose | | | |
| aspartame | cyclamate | | | |
| aspartame | NHDC | | | |
| aspartame | saccharine | | | |
| aspartame | alitame | | | |
| aspartame | inulin | | | |
| aspartame | isomalt | | | |
| aspartame | sucralose | | | |
| aspartame | maltol | | | |
| aspartame | maltodextrin | | | |
| cyclamate | sucralose | | | |
| cyclamate | sucrose | | | |
| cyclamate | fructose | | | |
| cyclamate | neotame | | | |
| cyclamate | maltol | | | |
| cyclamate | ethylmaltol | | | |
| saccharine | cyclamate | | | |
| isomalt | oligofructose | | | |
| isomalt | sorbitol | | | |
| isomalt | inulin | | | |
| isomalt | NHDC | | | |
| isomalt | HSH | | | |
| sorbitol | HSH | | | |
| maltitol | HSH | | | |
| sorbitol | polydextrose | | | |
| lactitol | polydextrose | | | |
| sorbitol | xylitol | | | |
| sorbitol | xylitol | | | |
| maltitol | polydextrose | | | |
| maltitol | sorbitol | | | |
| sucrose | fructose | | | |
| sucrose | polydextrin | | | |
| aspartame | sorbitol | polydextrose | | |
| aspartame | saccharin | fructose | | |
| aspartame | saccharin | sucrose | | |
| aspartame | saccharin | cyclamate | | |
| aspartame | cyclamate | fructose | | |
| aspartame | fructose | inulin | | |
| aspartame | sucralose | sucrose | | |
| cyclamate | sucralose | sucrose | | |
| cyclamate | saccharine | sucralose | | |
| cyclamate | neotame | sucrose | | |
| sucrose | maltodextrin | inulin | | |
| isomalt | sorbitol | polydextrose | | |
| isomalt | lactitol | polydextrose | | |
| isomalt | sorbitol | fructose | | |
| maltitol | sorbitol | polydextrose | | |
| isomalt | maltitol | xylitol | | |
| isomalt | maltitol | sorbitol | | |
| aspartame | sucrose | fructose | | |
| polydextrose | sucrose | maltodextrin | | |
| polydextrose | sorbitol | maltodextrin | | |
| dextrose | polydextrose | fructose | | |
| aspartame | cyclamate | saccharine | sucralose | |
| aspartame | sorbitol | polydextrose | sucrose | |
| isomalt | sorbitol | polydextrose | sucrose | |
| isomalt | sorbitol | polydextrose | fructose | |
| acesulfame K | alitame | | | |
| acesulfame K | aspartame | | | |
| acesulfame K | cyclamate | | | |
| acesulfame K | saccharine | | | |
| acesulfame K | neotame | | | |
| acesulfame K | sucrose | | | |
| acesulfame K | sucralose | | | |
| acesulfame K | fructose | | | |
| acesulfame K | isomalt | | | |
| acesulfame K | polydextrose | | | |
| acesulfame K | oligofructose | | | |
| acesulfame K | sorbitol | | | |
| acesulfame K | HSH | | | |
| acesulfame K | maltitol | | | |
| acesulfame K | alitame | fructose | | |
| acesulfame K | aspartame | fructose | | |
| acesulfame K | aspartame | sucrose | | |
| acesulfame K | aspartame | sucrose | | |
| acesulfame K | aspartame | cyclamate | | |
| acesulfame K | aspartame | NHDC | | |
| acesulfame K | aspartame | saccharine | | |
| acesulfame K | aspartame | alitame | | |
| acesulfame K | aspartame | inulin | | |
| acesulfame K | aspartame | isomalt | | |
| acesulfame K | aspartame | sucralose | | |
| acesulfame K | aspartame | maltol | | |
| acesulfame K | aspartame | maltodextrin | | |
| acesulfame K | cyclamate | sucralose | | |
| acesulfame K | cyclamate | sucrose | | |
| acesulfame K | cyclamate | fructose | | |
| acesulfame K | cyclamate | neotame | | |
| acesulfame K | cyclamate | maltol | | |
| acesulfame K | cyclamate | ethylmaltol | | |
| acesulfame K | saccharine | cyclamate | | |
| acesulfame K | isomalt | oligofructose | | |
| acesulfame K | isomalt | sorbitol | | |
| acesulfame K | isomalt | inulin | | |
| acesulfame K | isomalt | NHDC | | |
| acesulfame K | isomalt | HSH | | |
| acesulfame K | sorbitol | HSH | | |
| acesulfame K | maltitol | HSH | | |
| acesulfame K | sorbitol | polydextrose | | |
| acesulfame K | lactitol | polydextrose | | |
| acesulfame K | sorbitol | xylitol | | |
| acesulfame K | maltitol | polydextrose | | |
| acesulfame K | maltitol | sorbitol | | |
| acesulfame K | sucrose | fructose | | |
| acesulfame K | sucrose | polydextrin | | |
| acesulfame K | aspartame | sorbitol | polydextrose | |
| acesulfame K | aspartame | saccharin | fructose | |
| acesulfame K | aspartame | saccharin | sucrose | |
| acesulfame K | aspartame | saccharin | cyclamate | |
| acesulfame K | aspartame | cyclamate | fructose | |
| acesulfame K | aspartame | fructose | inulin | |
| acesulfame K | aspartame | sucralose | sucrose | |
| acesulfame K | cyclamate | sucralose | sucrose | |
| acesulfame K | cyclamate | saccharine | sucralose | |
| acesulfame K | cyclamate | neotame | sucrose | |
| acesulfame K | sucrose | maltodextrin | inulin | |
| acesulfame K | isomalt | sorbitol | polydextrose | |
| acesulfame K | isomalt | lactitol | polydextrose | |
| acesulfame K | isomalt | sorbitol | fructose | |
| acesulfame K | maltitol | sorbitol | polydextrose | |
| acesulfame K | isomalt | maltitol | xylitol | |
| acesulfame K | isomalt | maltitol | sorbitol | |
| acesulfame K | aspartame | sucrose | fructose | |
| acesulfame K | polydextrose | sucrose | maltodextrin | |
| acesulfame K | polydextrose | sorbitol | maltodextrin | |
| acesulfame K | dextrose | polydextrose | fructose | |
| acesulfame K | aspartame | cyclamate | saccharine | sucralose |
| acesulfame K | aspartame | sorbitol | polydextrose | sucrose |
| acesulfame K | isomalt | sorbitol | polydextrose | sucrose |
| acesulfame K | isomalt | sorbitol | polydextrose | fructose |

In other embodiments, rosmarinic acid or a derivative or a stereoisomer or a salt or a hydrate thereof may be combined with one or more, e.g., two or more or three or more, sweetener(s), e.g. sugar(s) and/or sweetness enhancer(s) that are known in the art but are not listed in Table 1. It should be understood that rosmarinic acid or a derivative or a stereoisomer or a salt or a hydrate thereof may, in some embodiments, be combined with at least one of any of the sweetener(s), e.g. sugar(s) and/or sweetness enhancer(s) that are listed in Table 1 and/or with any other sweetener(s), e.g. sugar(s) and/or sweetness enhancer(s) that are known in the art but are not listed in Table 1.

In some embodiments, when rosmarinic acid or a derivative or a stereoisomer or a salt or a hydrate thereof used with comestible goods such as, e.g., bakery goods, biscuits, cake, other bakery goods, spread, confectionary, delicacies, ice cream, water-based ice, jams, oral hygiene, desserts, or yoghurt, rosmarinic acid or a derivative or a stereoisomer or a salt or a hydrate thereof may be combined with one or more sweetener(s), e.g. sugar(s) and/or sweetness enhancer(s) as follows:
(a) acesulfame K in a concentration range of from 0.01 to 50 g/kg, more preferably from 0.05 to 20 g/kg, even more preferably from 0.1 to 10 g/kg, most preferably of from 0.1 to 8.3 g/kg;
(b) aspartame in a concentration range of from 0.005 to 10 g/kg, more preferably from 0.01 to 7 g/kg, even more preferably from 0.01 to 1 g/kg, most preferably of from 0.06 to 1 g/kg;
(c) cyclamate in a concentration range of from 0.01 to 10.0 g/kg, more preferably from 0.05 to 5 g/kg, even more preferably from 0.1 to 2 g/kg, most preferably of from 0.1 to 1.5 g/kg;
(d) sucralose in a concentration range of from 0.05 to 10 g/kg, more preferably from 0.05 to 5 g/kg, even more preferably from 0.1 to 1 g/kg, most preferably of from 0.1 to 0.36 g/kg;
(e) saccharine in a concentration range of from 0.001 to 20 g/kg, more preferably from 0.001 to 1 g/kg, even more preferably from 0.005 to 0.5 g/kg, most preferably of from 0.03 to 0.15 g/kg;
(f) alitame in a concentration range of from 0.001 to 1 g/kg, more preferably from 0.001 to 0.5 g/kg, even more preferably from 0.005 to 0.1 g/kg, most preferably of from 0.01 to 0.03 g/kg;
(g) NHDC in a concentration range of from 0.0001 to 0.1 g/kg, more preferably from 0.0005 to 0.01 g/kg, even more preferably from 0.001 to 0.01 g/kg, most preferably of from 0.002 to 0.005 g/kg;
(h) sucrose in a concentration range of from 0.1 to 900 g/kg, more preferably from 1 to 500 g/kg, even more preferably from 10 to 500 g/kg, most preferably of from 10 to 300 g/kg;
(i) fructose in a concentration range of from 0.1 to 900 g/kg, more preferably from 1 to 500 g/kg, even more preferably from 5 to 500 g/kg, most preferably of from 5 to 100 g/kg;
(j) isomalt in a concentration range of from 10 to 950 g/kg, more preferably from 20 to 950 g/kg, even more preferably from 40 to 950 g/kg, most preferably of from 50 to 900 g/kg;
(k) maltitol in a concentration range of from 10 to 950 g/kg, more preferably from 15 to 950 g/kg, even more preferably from 25 to 950 g/kg, most preferably of from 50 to 900 g/kg;
(l) sorbitol in a concentration range of from 5 to 750 g/kg, more preferably from 10 to 500 g/kg, even more preferably from 20 to 500 g/kg, most preferably of from 30 to 300 g/kg;
(m) polydextrose in a concentration range of from 5 to 750 g/kg, more preferably from 10 to 750 g/kg, even more preferably from 20 to 500 g/kg, most preferably of from 30 to 300 g/kg;
(n) HSH in a concentration range of from 5 to 950 g/kg, more preferably from 25 to 800 g/kg, even more preferably from 50 to 750 g/kg, most preferably of from 100 to 650 g/kg;
(o) oligofructose in a concentration range of from 5 to 800 g/kg, more preferably from 25 to 750 g/kg, even more preferably from 50 to 500 g/kg, most preferably of from 70 to 200 g/kg;
(p) inulin in a concentration range of from 5 to 500 g/kg, more preferably from 25 to 250 g/kg, even more preferably from 50 to 100 g/kg, most preferably of from 20 to 70 g/kg;
(q) lactitol in a concentration range of from 5 to 500 g/kg, more preferably from 25 to 250 g/kg, even more preferably from 50 to 100 g/kg, most preferably of from 40 to 60 g/kg;
(r) xylitol in a concentration range of from 5 to 500 g/kg, more preferably from 10 to 250 g/kg, even more preferably from 25 to 100 g/kg, most preferably of from 40 to 300 g/kg; and/or
(s) maltodextrin in a concentration range of from 10 to 500 g/kg, more preferably from 25 to 250 g/kg, even more preferably from 50 to 100 g/kg, most preferably of from 75 to 100 g/kg.

The proposed combinations and concentration ranges listed above are merely exemplary and are not meant to limit the scope of the invention.

In other embodiments, in a liquid comestible good such as, e.g., a drink or a beverage, rosmarinic acid or a derivative or a stereoisomer or a salt or a hydrate thereof may be combined with one or more sweetener(s), e.g. sugar(s) and/or sweetness enhancer(s) as follows:
(a) acesulfame K in a concentration range of from 0.005 to 5 g/l, more preferably from 0.005 to 1 g/l, even more preferably from 0.01 to 0.5 g/l, most preferably of from 0.04 to 0.45 g/l;
(b) aspartame in a concentration range of from 0.005 to 5.0 g/l, more preferably from 0.005 to 1 g/l, even more preferably from 0.01 to 0.5 g/l, most preferably of from 0.03 to 0.26 g/l;
(c) cyclamate in a concentration range of from 0.005 to 10 g/l, more preferably from 0.01 to 2 g/l, even more preferably from 0.05 to 1 g/l, most preferably of from 0.2 to 0.7 g/l;
(d) sucralose in a concentration range of from 0.005 to 20 g/l, more preferably from 0.005 to 5 g/l, even more preferably from 0.01 to 2 g/l, most preferably of from 0.01 to 0.77 g/l;
(e) neotame in a concentration range of from 0.0001 to 2 g/l, more preferably from 0.0005 to 0.5 g/l, even more preferably from 0.001 to 0.02 g/l, most preferably of from 0.002 to 0.007 g/l;
(f) alitame in a concentration range of from 0.001 to 20 g/l, more preferably from 0.005 to 0.5 g/l, even more preferably from 0.01 to 0.1 g/l, most preferably of from 0.025 to 0.030 g/l;
(g) sucralose in a concentration range of from 0.001 to 20 g/l, more preferably from 0.001 to 1 g/l, even more preferably from 0.005 to 0.1 g/l, most preferably of from 0.01 to 0.1 g/l;
(h) saccharine in a concentration range of from 0.001 to 20 g/l, more preferably from 0.001 to 1 g/l, even more preferably from 0.005 to 0.2 g/l, most preferably of from 0.03 to 0.09 g/l;
(i) NHCD in a concentration range of from 0.0001 to 0.1 g/l, more preferably from 0.0005 to 0.1 g/l, even more preferably from 0.001 to 0.01 g/l, most preferably of approximately 0.005 g/l;
(j) maltol in a concentration range of from 0.001 to 20 g/l, more preferably from 0.001 to 1.0 g/l, even more preferably from 0.005 to 0.2 g/l, most preferably of approximately 0.02 g/l;
(k) ethylmaltol in a concentration range of from 0.0001 to 2 g/l, more preferably from 0.0001 to 0.1 g/l, even more preferably from 0.0005 to 0.002 g/l, most preferably of from 0.007 to 0.020 g/l;
(l) sucrose in a concentration range of from 0.1 to 500 g/l, more preferably from 1 to 100 g/l, even more preferably from 10 to 100 g/l, most preferably of from 15 to 70 g/l; and/or
(m) fructose in a concentration range of from 0.1 to 500 g/l, more preferably from 1 to 100 g/l, even more preferably from 5 to 100 g/l, most preferably of from 10 to 20 g/l.

The proposed combinations and concentration ranges listed above are merely exemplary and are not meant to limit the scope of the invention.

In other embodiments, in a liquid or solid table top sweetener, rosmarinic acid or a derivative or a stereoisomer or a salt or a hydrate thereof may preferably be combined with one or more sweetener(s), e.g. sugar(s) and/or sweetness enhancer(s) as follows:
(a) acesulfame K in a concentration range of from 0.5 to 500 g/kg, more preferably from 1 to 250 g/kg, even more preferably from 5 to 150 g/kg, most preferably of from 5 to 135 g/kg;
(b) aspartame in a concentration range of from 0.5 to 200 g/kg, more preferably from 1 to 100 g/kg, even more preferably from 2 to 50 g/kg, most preferably of from 5 to 30 g/kg;
(c) cyclamate in a concentration range of from 1 to 500 g/kg, more preferably from 5 to 250 g/kg, even more preferably from 10 to 150 g/kg, most preferably of from 30 to 130 g/kg;
(d) sucralose in a concentration range of from 0.1 to 200 g/kg, more preferably from 0.5 to 100 g/kg, even more preferably from 1 to 50 g/kg, most preferably of from 1.5 to 20 g/kg;
(e) saccharin in a concentration range of from 0.1 to 200 g/kg, more preferably from 0.5 to 100 g/kg, even more preferably from 1 to 50 g/kg, most preferably of from 3 to 10 g/kg;
(f) NHCD in a concentration range of from 0.1 to 200 g/kg, more preferably from 0.5 to 100 g/kg, even more preferably from 1 to 50 g/kg, most preferably of from 1 to 5 g/kg;
(g) dextrose in a concentration range above 100 g/kg, more preferably above 250 g/kg, even more preferably above 500 g/kg, most preferably above 900 g/kg;
(h) maltodextrin in a concentration range above 100 g/kg, more preferably above 250 g/kg, even more preferably above 500 g/kg, most preferably above 900 g/kg;
(i) lactose in a concentration range above 50 g/kg, more preferably above 100 g/kg, even more preferably above 500 g/kg, most preferably above 800 g/kg.

The proposed combinations and concentration ranges listed above are merely exemplary and are not meant to limit the scope of the invention.

In other embodiments, when rosmarinic acid or a derivative or a stereoisomer or a salt or a hydrate thereof is used with comestible goods, the inventive compound may be combined with one or more, e.g., two or more or three or more, sweetener(s), e.g. sugar(s) and/or sweetness enhancer(s) that are known in the art but are not listed above. It should be understood that rosmarinic acid or a derivative or a stereoisomer or a salt or a hydrate thereof may, in some embodiments, be combined with at least one of any of the sweetener(s), e.g. sugar(s) and/or sweetness enhancer(s) that are listed above and/or with any other sweetener(s), e.g. sugar(s) and/or sweetness enhancer(s) that are known in the art.

In other embodiments, rosmarinic acid or a derivative or a stereoisomer or a salt or a hydrate thereof, when used as an additive in a comestible good such as, e.g., bakery goods, biscuits, cake, other bakery goods, spread, confectionary, delicacies, ice cream, water-based ice, jams, oral hygiene, desserts, or yoghurt, may be combined with sweetener(s), sweetness enhancer(s), and/or sugar(s) as shown in Table 2 below. The combinations in Table 2 are merely exemplary and are not meant to limit the scope of the invention.

TABLE 2
Mass ranges - Solid and Semi-Solid Compositions

| | Additive 2 | Additive 3 | Additive 4 | Additive 5 |
|---|---|---|---|---|
| Additive 1 | (opt.) | (opt.) | (opt.) | (opt.) |
| acesulfame K: | | | | |
| 0.8-2 g/kg | | | | |
| alitame: | | | | |
| 0.01-1.0 g/kg | | | | |
| aspartame: | | | | |
| 0.16-6.2 g/kg | | | | |
| cyclamate: | | | | |
| 0.1-10 g/kg | | | | |
| saccharine: | | | | |
| 0.1-10 g/kg | | | | |
| sucrose: | | | | |
| 1-100 g/kg | | | | |
| sucralose: | | | | |
| 0.10-0.36 g/kg | | | | |
| fructose: | | | | |
| 1-100 g/kg | | | | |
| isomalt: | | | | |
| 144.92-881.3 g/kg | | | | |
| isomalt: | | | | |
| 144.92-881.3 g/kg | | | | |
| polydextrose: | | | | |
| 10-500 g/kg | | | | |
| oligofructose: | | | | |
| 10-500 g/kg | | | | |
| sucralose: | | | | |
| 0.1-10 g/kg | | | | |
| sorbitol | | | | |
| 280.7-979.0 g/kg | | | | |
| HSH: | | | | |
| 796.8-981.0 g/kg | | | | |
| maltitol: | | | | |
| 851.0-851.1 g/kg | | | | |
| alitame: | fructose: | | | |
| 0.01-1 g/kg | 1-100 g/kg | | | |
| aspartame: | fructose: | | | |
| 0.10-0.16 g/kg | 8.0-10.0 g/kg | | | |
| aspartame: | sucrose: | | | |
| 0.10-0.3 g/kg | 20.0-225.0 g/kg | | | |
| aspartame: | cyclamate | | | |
| 0.14-0.28 g/kg | 0.12-1.2 g/kg | | | |
| aspartame: | NHDC: | | | |
| 0.15-0.18 g/kg | 0.002-0.005 g/kg | | | |
| aspartame: | saccharine: | | | |
| 0.06-0.14 g/kg | 0.03-0.08 g/kg | | | |
| aspartame: | alitame: | | | |
| 0.01-1 g/kg | 0.001-1 g/kg | | | |
| aspartame: | inulin: | | | |
| 0.01-1 g/kg | 1-100 g/kg | | | |
| aspartame: | isomalt: | | | |
| 0.01-10 g/kg | 10-1000 g/kg | | | |
| aspartame: | sucralose: | | | |
| 0.01-10 g/kg | 0.01-1 g/kg | | | |
| cyclamate: | fructose: | | | |
| 0.01-10 g/kg | 10-20.0 g/kg | | | |
| cyclamate: | sucralose: | | | |
| 0.1-10 g/kg | 0.01-1 g/kg | | | |
| isomalt: | oligofructose: | | | |
| 72.46-93.5 g/kg | 72.46-93.5 g/kg | | | |
| sorbitol: | polydextrose: | | | |
| 1-500 g/kg | 10-1000 g/kg | | | |
| lactitol: | polydextrose: | | | |
| 1-500 g/kg | 10-1000 g/kg | | | |
| maltitol: | polydextrose: | | | |
| 34.0-135.2 g/kg | 33.0-134.4 g/kg | | | |
| maltitol: | sorbitol: | | | |
| 199.8-266.7 g/kg | 176.0-281.3 g/kg | | | |
| isomalt: | polydextrose: | | | |
| 33.8-476.0 g/kg | 33.6-315.7 g/kg | | | |
| isomalt: | inulin: | | | |
| 1-500 g/kg | 10-1000 g/kg | | | |
| isomalt: | sorbitol: | | | |
| 1-500 g/kg | 10-1000 g/kg | | | |
| isomalt: | HSH: | | | |
| 10-1000 g/kg | 10-1000 g/kg | | | |
| sorbitol: | HSH: | | | |
| 56.3-75.6 g/kg | 482.1-639.5 g/kg | | | |
| maltitol: | HSH: | | | |
| 100-5000 g/kg | 10-1000 g/kg | | | |
| sorbitol: | xylitol: | | | |
| 10-1000 g/kg | 10-1000 g/kg | | | |
| isomalt: | xylitol: | | | |
| 345.0-400.7 g/kg | 40.0-41.0 g/kg | | | |
| isomalt: | NHDC: | | | |
| 10-1000 g/kg | 0.001-1 g/kg | | | |
| sucrose: | fructose: | | | |
| 10-1000 g/kg | 10-1000 g/kg | | | |
| sucrose: | maltodextrin: | | | |
| 10-1000 g/kg | 10-1000 g/kg | | | |
| sucrose: | polydextrose: | | | |
| 10-1000 g/kg | 10-1000 g/kg | | | |
| aspartam: | sorbitol: | polydextrose: | | |
| 0.25-0.55 g/kg | 10-1000 g/kg | 159.0-160.0 g/kg | | |
| aspartame: | saccharine: | fructose: | | |
| 0.01-1 g/kg | 0.1-10 g/kg | 1-1000 g/kg | | |
| aspartame: | saccharine: | sucrose: | | |
| 0.06-0.09 g/kg | 0.03-0.08 g/kg | 1-1000 g/kg | | |
| aspartame: | cyclamate: | fructose: | | |
| 0.01-1 g/kg | 0.1-10 g/kg | 1-1000 g/kg | | |
| aspartame: | isomalt: | polydextrose: | | |
| 0.01-1 g/kg | 1-100 g/kg | 1-1000 g/kg | | |
| aspartame: | sucrose: | fructose: | | |
| 0.01-1 g/kg | 10-1000 g/kg | 1-1000 g/kg | | |
| isomalt: | sorbitol: | fructose: | | |
| 1-500 g/kg | 10-1000 g/kg | 1-1000 g/kg | | |
| isomalt: | sorbitol: | polydextrose: | | |
| 63.8-344.6 g/kg | 31.9-51.7 g/kg | 53.9-170.2 g/kg | | |
| isomalt: | lactitol: | polydextrose: | | |
| 1-500 g/kg | 10-1000 g/kg | 1-1000 g/kg | | |
| isomalt: | polydextrose: | inulin: | | |
| 10-1000 g/kg | 10-1000 g/kg | 1-1000 g/kg | | |
| isomalt: | maltitol: | xylitol: | | |
| 10-1000 g/kg | 10-1000 g/kg | 1-1000 g/kg | | |
| dextrose: | polydextrose: | fructose: | | |
| 1-500 g/kg | 10-1000 g/kg | 1-1000 g/kg | | |
| polydextrose: | sucrose: | maltodextrin: | | |
| 1-1000 g/kg | 10-1000 g/kg | 1-1000 g/kg | | |
| polydextrose: | sorbitol: | maltodextrin: | | |
| 10-1000 g/kg | 10-1000 g/kg | 1-1000 g/kg | | |
| polydextrose: | maltitol: | HSH: | | |
| 203.6-296.8 g/kg | 10-1000 g/kg | 226.0-340.0 g/kg | | |
| aspartame: | sorbitol: | polydextrose: | sucrose: | |
| 0.01-1 g/kg | 10-1000 g/kg | 1-1000 g/kg | 10-1000 g/kg | |
| isomalt: | sorbitol: | polydextrose: | sucrose: | |
| 1-500 g/kg | 1-1000 g/kg | 1-1000 g/kg | 10-1000 g/kg | |
| isomalt: | sorbitol: | polydextrose: | fructose: | |
| 1-500 g/kg | 1-100 g/kg | 1-1000 g/kg | 10-1000 g/kg | |
| acesulfame K: | alitame: | | | |
| 0.01-1 g/kg | 0.01-1 g/kg | | | |
| acesulfame K: | aspartame: | | | |
| 0.16-6.2 g/kg | 0.16-6.2 g/kg | | | |
| acesulfame K: | cyclamate: | | | |
| 0.25-0.5 g/kg | 0.01-10 g/kg | | | |
| acesulfame K: | saccharine: | | | |
| 0.01-1 g/kg | 0.1-1 g/kg | | | |
| acesulfame K: | sucrose: | | | |
| 0.01-1 g/kg | 1-100 g/kg | | | |
| acesulfame K: | sucralose: | | | |
| 0.32-0.92 g/kg | 0.10-0.36 g/kg | | | |
| acesulfame K: | fructose: | | | |
| 0.01-1 g/kg | 1-100 g/kg | | | |
| acesulfame K: | isomalt: | | | |
| 0.1-2 g/kg | 144.92-881.3 g/kg | | | |
| acesulfame K: | isomalt: | | | |
| 0.1-2 g/kg | 144.92-881.3 g/kg | | | |
| acesulfame K: | polydextrose: | | | |
| 0.01-1 g/kg | 1-1000 g/kg | | | |
| acesulfame K: | oligofructose: | | | |
| 1-10 g/kg | 1-1000 g/kg | | | |
| acesulfame K: | sucralose: | | | |
| 0.27 g/kg | 0.01-10 g/kg | | | |
| acesulfame K: | sorbitol | | | |
| 0.01-1 g/kg | 280.7-979.0 g/kg | | | |
| acesulfame K: | HSH: | | | |
| 1.5-1.6 g/kg | 796.8-981.0 g/kg | | | |
| acesulfame K: | maltitol: | | | |
| 0.3-0.4 g/kg | 851.0-851.1 g/kg | | | |
| acesulfame K: | alitame: | fructose: | | |
| 0.01-1 g/kg | 0.001-1 g/kg | 0.1-100 g/kg | | |
| acesulfame K: | aspartame: | fructose: | | |
| 0.13-0.20 g/kg | 0.10-0.16 g/kg | 8.0-10.0 g/kg | | |
| acesulfame K: | aspartame: | sucrose: | | |
| 0.12-0.3 g/kg | 0.10-0.3 g/kg | 20.0-225.0 g/kg | | |
| acesulfame K: | aspartame: | cyclamate | | |
| 0.14-0.67 g/kg | 0.14-0.28 g/kg | 0.12-1.2 g/kg | | |
| acesulfame K: | aspartame: | NHDC: | | |
| 0.15-0.18 g/kg | 0.15-0.18 g/kg | 0.002-0.005 g/kg | | |
| acesulfame K: | aspartame: | saccharine: | | |
| 0.06-0.14 g/kg | 0.06-0.14 g/kg | 0.03-0.08 g/kg | | |
| acesulfame K: | aspartame: | alitame: | | |
| 0.01-1 g/kg | 0.01-1 g/kg | 0.001-1 g/kg | | |
| acesulfame K: | aspartame: | inulin: | | |
| 0.01-1 g/kg | 0.01-10 g/kg | 1-1000 g/kg | | |
| acesulfame K: | aspartame: | isomalt: | | |
| 0.01-1 g/kg | 0.01-1 g/kg | 10-1000 g/kg | | |
| acesulfame K: | aspartame: | sucralose: | | |
| 1-10 g/kg | 0.01-1 g/kg | 0.01-1 g/kg | | |
| acesulfame K: | cyclamate: | fructose: | | |
| 0.20-0.35 g/kg | 0.01-1 g/kg | 10-20.0 g/kg | | |
| acesulfame K: | cyclamate: | sucralose: | | |
| 0.1-10 g/kg | 0.1-10 g/kg | 0.01-1 g/kg | | |
| acesulfame K: | isomalt: | oligofructose: | | |
| 0.1-1 g/kg | 72.46-93.5 g/kg | 72.46-93.5 g/kg | | |
| acesulfame K: | sorbitol: | polydextrose: | | |
| 0.1-1 g/kg | 10-1000 g/kg | 10-1000 g/kg | | |
| acesulfame K: | lactitol: | polydextrose: | | |
| 0.1-1 g/kg | 10-1000 g/kg | 10-1000 g/kg | | |
| acesulfame K: | maltitol: | polydextrose: | | |
| 0.1-10 g/kg | 34.0-135.2 g/kg | 33.0-134.4 g/kg | | |
| acesulfame K: | maltitol: | sorbitol: | | |
| 0.1-10 g/kg | 199.8-266.7 g/kg | 176.0-281.3 g/kg | | |
| acesulfame K: | isomalt: | polydextrose: | | |
| 0.65-3.2 g/kg | 33.8-476.0 g/kg | 33.6-315.7 g/kg | | |
| acesulfame K: | isomalt: | inulin: | | |
| 0.1-10 g/kg | 10-1000 g/kg | 10-1000 g/kg | | |
| acesulfame K: | isomalt: | sorbitol: | | |
| 0.1-10 g/kg | 10-1000 g/kg | 10-1000 g/kg | | |
| acesulfame K: | isomalt: | HSH: | | |
| 1-10 g/kg | 10-2000 g/kg | 10-1000 g/kg | | |
| acesulfame K: | sorbitol: | HSH: | | |
| 0.4-1.4 g/kg | 56.3-75.6 g/kg | 10-1000 g/kg | | |
| acesulfame K: | maltitol: | HSH: | | |
| 0.1-1 g/kg | 100-10000 g/kg | 10-1000 g/kg | | |
| acesulfame K: | sorbitol: | xylitol: | | |
| 0.1-1 g/kg | 10-1000 g/kg | 10-1000 g/kg | | |
| acesulfame K: | isomalt: | xylitol: | | |
| 0.1-1 g/kg | 345.0-400.7 g/kg | 40.0-41.0 g/kg | | |
| acesulfame K: | isomalt: | NHDC: | | |
| 0.1-1 g/kg | 100-10000 g/kg | 0.001-1 g/kg | | |
| acesulfame K: | sucrose: | fructose: | | |
| 1-10 g/kg | 10-1000 g/kg | 1-1000 g/kg | | |
| acesulfame K: | sucrose: | maltodextrin: | | |
| 1-10 g/kg | 10-1000 g/kg | 10-1000 g/kg | | |
| acesulfame K: | sucrose: | polydextrose: | | |
| 1-10 g/kg | 10-1000 g/kg | 10-1000 g/kg | | |
| acesulfame K: | aspartam: | sorbitol: | polydextrose: | |
| 0.25-0.55 g/kg | 0.25-0.55 g/kg | 10-1000 g/kg | 159.0-160.0 g/kg | |
| acesulfame K: | aspartame: | saccharine: | fructose: | |
| 0.01-1 g/kg | 0.01-1 g/kg | 0.001-10 g/kg | 1-1000 g/kg | |
| acesulfame K: | aspartame: | saccharine: | sucrose: | |
| 0.06-0.09 g/kg | 0.06-0.09 g/kg | 0.001-10 g/kg | 1-1000 g/kg | |
| acesulfame K: | aspartame: | cyclamate: | fructose: | |
| 0.01-1 g/kg | 0.01-1 g/kg | 0.01-1 g/kg | 1-1000 g/kg | |
| acesulfame K: | aspartame: | isomalt: | polydextrose: | |
| 0.01-1 g/kg | 0.01-1 g/kg | 0.01-1 g/kg | 1-1000 g/kg | |
| acesulfame K: | aspartame: | sucrose: | fructose: | |
| 0.01-1 g/kg | 0.01-1 g/kg | 10-1000 g/kg | 10-1000 g/kg | |
| acesulfame K: | isomalt: | sorbitol: | fructose: | |
| 0.01-1 g/kg | 10-1000 g/kg | 10-1000 g/kg | 10-1000 g/kg | |
| acesulfame K: | isomalt: | sorbitol: | polydextrose: | |
| 0.7-1.2 g/kg | 63.8-344.6 g/kg | 31.9-51.7 g/kg | 53.9-170.2 g/kg | |
| acesulfame K: | isomalt: | lactitol: | polydextrose: | |
| 0.1-1 g/kg | 10-1000 g/kg | 10-1000 g/kg | 1-1000 g/kg | |
| acesulfame K: | isomalt: | polydextrose: | inulin: | |
| 1-10 g/kg | 10-1000 g/kg | 10-1000 g/kg | 1-1000 g/kg | |
| acesulfame K: | isomalt: | maltitol: | xylitol: | |
| 0.01-1 g/kg | 10-1000 g/kg | 10-1000 | 10-1000 g/kg | |
| acesulfame K: | dextrose: | polydextrose: | fructose: | |
| 1-10 g/kg | 10-1000 g/kg | 10-1000 g/kg | 10-1000 g/kg | |
| acesulfame K: | polydextrose: | sucrose: | maltodextrin: | |
| 1-10 g/kg | 10-1000 g/kg | 10-1000 g/kg | 10-1000 g/kg | |
| acesulfame K: | polydextrose: | sorbitol: | maltodextrin: | |
| 1-10 g/kg | 10-1000 g/kg | 10-1000 g/kg | 10-1000 g/kg | |
| acesulfame K: | polydextrose: | maltitol: | HSH: | |
| 1.8-8.3 g/kg | 203.6-296.8 g/kg | 10-1000 g/kg | 226.0-340.0 g/kg | |
| acesulfame K: | aspartame: | sorbitol: | polydextrose: | sucrose: |
| 0.01-1 g/kg | 0.01-1 g/kg | 10-1000 g/kg | 10-1000 g/kg | 10-1000 g/kg |
| acesulfame K: | isomalt: | sorbitol: | polydextrose: | sucrose: |
| 0.1-10 g/kg | 10-1000 g/kg | 10-1000 g/kg | 10-1000 g/kg | 10-1000 g/kg |
| acesulfame K: | isomalt: | sorbitol: | polydextrose: | fructose: |
| 0.1-10 g/kg | 10-1000 g/kg | 10-1000 g/kg | 10-1000 g/kg | 10-1000 g/kg |

In other embodiments, rosmarinic acid or a derivative or a stereoisomer or a salt or a hydrate thereof, when used as an additive in a beverage or a drink, may be combined with sweetener(s), sweetness enhancer(s), and/or sugar(s) as shown in Table 3 below. The combinations in Table 3 are merely exemplary and are not meant to limit the scope of the invention.

TABLE 3
Mass ranges - Beverages and Drinks

| | Additive 2 | Additive 3 | Additive 4 | Additive 5 |
|---|---|---|---|---|
| Additive 1 | (opt.) | (opt.) | (opt.) | (opt.) |
| aspartame: | | | | |
| 0.04-0.26 g/l | | | | |
| cyclamate: | | | | |
| 0.28-0.72 g/l | | | | |
| sucrose: | | | | |
| 40.0-70.0 g/l | | | | |
| sucralose: | | | | |
| 0.073-0.77 g/l | | | | |
| neotame: | | | | |
| 0.006-0.007 g/l | | | | |
| alitame: | | | | |
| 0.025-0.030 g/l | | | | |
| aspartame: | sucralose: | | | |
| 0.09-0.13 g/l | 0.01-0.06 g/l | | | |
| aspartame: | cyclamate: | | | |
| 0.04-0.10 g/l | 0.22-0.40 g/l | | | |
| aspartame: | saccharine: | | | |
| 0.09-0.18 g/l | 0.03-0.08 g/l | | | |
| aspartame: | fructose: | | | |
| 0.04-0.13 g/l | 10.0-20.0 g/l | | | |
| aspartame: | sucrose: | | | |
| 0.06-0.16 g/l | 20.0-65.0 g/l | | | |
| aspartame: | NHDC: | | | |
| 0.06-0.13 g/l | 0.0001-1 g/l | | | |
| aspartame: | maltol: | | | |
| 0.13-0.16 g/l | 0.001-1 g/l | | | |
| cyclamate: | sucralose: | | | |
| 0.2-0.4 g/l | 0.03-0.10 g/l | | | |
| cyclamate: | sucrose: | | | |
| 0.09-0.17 g/l | 10.0-35.0 g/l | | | |
| cyclamate: | saccharine: | | | |
| 0.28-0.40 g/l | 0.04-0.09 g/l | | | |
| cyclamate: | neotame: | | | |
| 0.43-0.44 g/l | 0.003-0.005 g/l | | | |
| cyclamate: | maltol: | | | |
| 0.01-1 g/l | 0.001-1 g/l | | | |
| cyclamate: | ethylmaltol: | | | |
| 0.08-0.40 g/l | 0.007-0.020 g/l | | | |
| sucralose: | sucrose: | | | |
| 0.01-1 g/l | 10-1000 g/l | | | |
| aspartame: | saccharine: | cyclamate: | | |
| 0.01-0.07 g/l | 0.02-0.09 g/l | 0.15-0.41 g/l | | |
| aspartame: | saccharine: | sucrose: | | |
| 0.08-0.13 g/l | 0.03-0.05 g/l | 15.0-30.0 g/l | | |
| aspartame: | sucralose: | sucrose: | | |
| 0.01-1 g/l | 0.001-1 g/l | 10-1000 g/l | | |
| cyclamate: | sucralose: | sucrose: | | |
| 0.01-1 g/l | 0.001-1 g/l | 10-1000 g/l | | |
| cyclamate: | saccharine: | sucralose: | | |
| 0.01-1 g/l | 0.03-0.09 g/l | 0.04-0.08 g/l | | |
| cyclamate: | neotame: | sucrose: | | |
| 0.01-1 g/l | 0.0001-1 g/l | 10-1000 g/l | | |
| aspartame: | cyclamate: | saccharine: | sucralose: | |
| 0.01-1 g/l | 0.01-1 g/l | 0.001-1 g/l | 0.001-1 g/l | |
| acesulfame K: | | | | |
| 0.20-0.45 g/l | | | | |
| acesulfame K: | aspartame: | | | |
| 0.07-0.28 g/l | 0.04-0.26 g/l | | | |
| acesulfame K: | cyclamate: | | | |
| 0.07-0.20 g/l | 0.28-0.72 g/l | | | |
| acesulfame K: | sucrose: | | | |
| 0.15-0.32 g/l | 40.0-70.0 g/l | | | |
| acesulfame K: | sucralose: | | | |
| 0.10-0.25 g/l | 0.073-0.77 g/l | | | |
| acesulfame K: | neotame: | | | |
| 0.15-0.24 g/l | 0.006-0.007 g/l | | | |
| acesulfame K: | alitame: | | | |
| 0.15-0.20 g/l | 0.025-0.030 g/l | | | |
| acesulfame K: | aspartame: | sucralose: | | |
| 0.09-0.19 g/l | 0.09-0.13 g/l | 0.01-0.06 g/l | | |
| acesulfame K: | aspartame: | cyclamate: | | |
| 0.04-0.10 g/l | 0.04-0.10 g/l | 0.22-0.40 g/l | | |
| acesulfame K: | aspartame: | saccharine: | | |
| 0.06-0.14 g/l | 0.09-0.18 g/l | 0.03-0.08 g/l | | |
| acesulfame K: | aspartame: | fructose: | | |
| 0.12-0.13 g/l | 0.04-0.13 g/l | 10.0-20.0 g/l | | |
| acesulfame K: | aspartame: | sucrose: | | |
| 0.06-0.13 g/l | 0.06-0.16 g/l | 20.0-65.0 g/l | | |
| acesulfame K: | aspartame: | NHDC: | | |
| 0.08-0.15 g/l | 0.06-0.13 g/l | 0.0001-1 g/l | | |
| acesulfame K: | aspartame: | maltol: | | |
| 0.13-0.16 g/l | 0.13-0.16 g/l | 0.0001-1 g/l | | |
| acesulfame K: | cyclamate: | sucralose: | | |
| 0.09-0.13 g/l | 0.2-0.4 g/l | 0.03-0.10 g/l | | |
| acesulfame K: | cyclamate: | sucrose: | | |
| 0.07-0.09 g/l | 0.09-0.17 g/l | 10.0-35.0 g/l | | |
| acesulfame K: | cyclamate: | saccharine: | | |
| 0.05-0.26 g/l | 0.28-0.40 g/l | 0.04-0.09 g/l | | |
| acesulfame K: | cyclamate: | neotame: | | |
| 0.21-0.29 g/l | 0.43-0.44 g/l | 0.003-0.005 | | |
| | | g/l | | |
| acesulfame K: | cyclamate: | maltol: | | |
| 0.01-1 g/l | 0.01-10 g/l | 0.001-1 g/l | | |
| acesulfame K: | cyclamate: | ethylmaltol: | | |
| 0.08-0.20 g/l | 0.08-0.40 g/l | 0.007-0.020 | | |
| | | g/l | | |
| acesulfame K: | sucralose: | sucrose: | | |
| 0.01-1 g/l | 0.01-1 g/l | 10-1000 g/l | | |
| acesulfame K: | aspartame: | saccharine: | cyclamate: | |
| 0.01-0.07 g/l | 0.01-0.07 g/l | 0.02-0.09 g/l | 0.15-0.41 g/l | |
| acesulfame K: | aspartame: | saccharine: | sucrose: | |
| 0.08-0.13 g/l | 0.08-0.13 g/l | 0.03-0.05 g/l | 15.0-30.0 g/l | |
| acesulfame K: | aspartame: | sucralose: | sucrose: | |
| 0.01-1 g/l | 0.01-1 g/l | 0.001-1 g/l | 10-1000 g/l | |
| acesulfame K: | cyclamate: | sucralose: | sucrose: | |
| 0.01-1 g/l | 0.01-1 g/l | 0.001-1 g/l | 10-1000 g/l | |
| acesulfame K: | cyclamate: | saccharine: | sucralose: | |
| 0.015-0.1 g/l | 0.01-1 g/l | 0.03-0.09 g/l | 0.04-0.08 g/l | |
| acesulfame K: | cyclamate: | neotame: | sucrose: | |
| 0.01-1 g/l | 0.01-1 g/l | 0.00001-1 | 10-1000 g/l | |
| | | g/l | | |
| acesulfame K: | aspartame: | cyclamate: | saccharine: | sucralose: |
| 0.01-1 g/l | 0.01-1 g/l | 0.01-10 g/l | .0001-1 g/l | 0.001-1 |
| | | | | g/l |

In other embodiments, rosmarinic acid or a derivative or a stereoisomer or a salt or a hydrate thereof, when used as table top sweetener, may be combined with sweetener(s), e.g. sugar(s), and/or sweetness enhancer(s) as shown in Table 4 below. The combinations in Table 4 are merely exemplary and are not meant to limit the scope of the invention.

TABLE 4
Mass ranges - Table Top Sweeteners

| | Additive 2 | Additive 3 | Additive 4 |
|---|---|---|---|
| Additive 1 | (opt.) | (opt.) | (opt.) |
| acesulfame K: | | | |
| 6.7-134.0 g/kg | | | |
| aspartame: | | | |
| 5.0-22.0 g/kg | | | |
| cyclamate: | | | |
| 28.0-120.0 g/kg | | | |
| lactose: | | | |
| 100-900.0 g/kg | | | |
| sucralose: | | | |
| 9.6-20.0 g/kg | | | |
| saccharin: | cyclamate: | | |
| 1-100 g/kg | 10-1000 g/kg | | |
| saccharin: | maltodextrin: | | |
| 13.0-20.0 g/kg | 100-10000 g/kg | | |
| aspartame: | dextrose | 1-100 g/kg | 100-10000 g/kg |
| sucralose: | dextrose | | |
| 3.4-5.0 g/kg | 984.1-982.5 g/kg | | |
| aspartame: | NHDC: | lactose: | |
| 1-100 g/kg | 1-100 g/kg | 10-10000 g/kg | |
| aspartame: | cyclamate: | lactose: | |
| 1-100 g/kg | 10-1000 g/kg | 10-10000 g/kg | |
| aspartame: | sucralose: | dextrose: | |
| 1-100 g/kg | 1.7-2.5 g/kg | 979.6-978.8 g/kg | |
| aspartame: | cyclamate: | maltodextrin: | |
| 1-100 g/kg | 1-1000 g/kg | 10-10000 g/kg | |
| saccharin: | cyclamate: | maltodextrin: | |
| 3.3-5.0 g/kg | 28.0-57.0 g/kg | 932.2-974.0 g/kg | |
| acesulfame K: | aspartame: | | |
| 24.0-110.0 g/kg | 5.0-22.0 g/kg | | |
| acesulfame K: | cyclamate: | | |
| 1-100 g/kg | 10-1000 g/kg | | |
| acesulfame K: | lactose: | | |
| 10-1000 g/kg | 100-10000 g/kg | | |
| acesulfame K: | sucralose: | | |
| 12.0-24.0 g/kg | 9.6-20.0 g/kg | | |
| acesulfame K: | saccharin: | cyclamate: | |
| 1-100 g/kg | 1-100 g/kg | 10-1000 g/kg | |
| acesulfame K: | saccharin: | maltodextrin: | |
| 10.0-13.0 g/kg | 13.0-20.0 g/kg | 970-974 g/kg | |
| acesulfame K: | aspartame: | dextrose | |
| 1-100 g/kg | 1-100 g/kg | 10-10000 g/kg | |
| acesulfame K: | sucralose: | dextrose | |
| 1-100 g/kg | 3.4-5.0 g/kg | 984.1-982.5 g/kg | |
| acesulfame K: | aspartame: | NHDC: | lactose: |
| 1-100 g/kg | 1-100 g/kg | 0.1-100 g/kg | 10-10000 g/kg |
| acesulfame K: | aspartame: | cyclamate: | lactose: |
| 1-100 g/kg | 1-100 g/kg | 10-1000 g/kg | 10-10000 g/kg |
| acesulfame K: | aspartame: | sucralose: | dextrose: |
| 1-100 g/kg | 1-100 g/kg | 1.7-2.5 g/kg | 100-10000 g/kg |
| acesulfame K: | aspartame: | 10-1000 g/kg | maltodextrin: |
| 1-100 g/kg | 1-100 g/kg | | 10-10000 g/kg |
| acesulfame K: | saccharin: | cyclamate: | maltodextrin: |
| 7.2-10.0 g/kg | 3.3-5.0 g/kg | 28.0-57.0 g/kg | 10-10000 g/kg |

In other embodiments, when rosmarinic acid or a derivative or a stereoisomer or a salt or a hydrate thereof is used with comestible goods, rosmarinic acid or a derivative or a stereoisomer or a salt or a hydrate thereof may be combined with one or more, e.g., two or more or three or more, sweetener(s), e.g. sugar(s) and/or sweetness enhancer(s) that are known in the art but are not listed above in Tables 2-4. It should be understood that sweetener(s), e.g. sugar(s) and/or sweetness enhancer(s) may, in some embodiments, be combined with at least one of any of the sweetener(s), e.g. sugar(s) and/or sweetness enhancer(s) that are listed above in Tables 2-4 and/or with any other sweetener(s), e.g. sugar(s) and/or sweetness enhancer(s) that are known in the art but are not listed in Tables 2-4.

### EXAMPLES

The following examples as well as the accompanying figures provide illustrative embodiments of the inventions described and claimed herein. These examples are not intended to provide any limitation on the scope of the invented subject-matter.

### Example 1

### In Vitro Identification of Rosmarinic Acid as a Sweet Taste Modulating Substance—Detection of Sweetness Enhancer Activity of Rosmarinic Acid in a Recombinant Human Taste Receptor T1R2/T1R3 Dependent Cell Based Assay

Rosmarinic acid has been identified in the screening phase as a sweet taste modulating substance by cell based assay analysis, acting as a fructose enhancer in vitro.

### 1.1 Description of the General Method

In wild type taste cells, e.g. in human taste buds, signal transduction is accomplished by the G-proteins gustducin and/or by G-Proteins of the G alpha-i type. Encountering sweet ligands, the heterodimeric human taste receptor T1R2/T1R3 reacts with induction of second messenger molecules, namely either the increase of the cAMP level in response to most sugars or the increase of the calcium level in response to most artificial sweeteners (Margolskee, 2002; J. Biol. Chem. 277, 1-4, which is incorporated by reference in its entirety).

To analyze the function and activity of a test compound, e.g. of rosmarinic acid, the heterodimeric hT1R2/hT1R3 sweet taste receptor is utilized in a calcium dependent cell based assay. T1R type taste receptors are transfected with the multicistronic plasmid vector pTrix-Eb-R2R3 in a HEK293 cell line stably expressing the promiscuous mouse G-alpha-15 G-protein.

For the generation of stable cell lines a multicistronic expression unit using human taste receptor sequences is used. In a tricistronic expression unit of the expression vector pTrix-Eb-R2R3 is under the control of the human elongation factor 1 alpha promoter. Using standard cloning techniques the cDNA for the receptors ht1R2 and ht1R3 and the cDNA for the blasticidin S deaminase gene is cloned. To enable the translation initiation of each gene of this tricistronic unit two EMC-virus derived internal ribosomal entry sites (IRES—also termed Cap-independent translation enhancer (CITE)) are inserted (Jackson et al., Trends Biochem Sci (1990) 15, 477-83; Jang et al., J Virol (1988) 62, 2636-43, which are incorporated by reference in their entirety).

The tricistronic expression unit is terminated by a simian virus 40 polyadenylation signal sequence. This composition permits the simultaneous expression of all three genes under the control of only one promoter. In contrast to monocistronic transcription units, which integrate independently from each other into different chromosomal locations during the process of stable cell line development, the tricistronic transcription unit integrates all containing genes in one and the same chromosomal locus. Due to the alignment of the genes, the blasticidin S deaminase gene is only transcribed in case a full length transcription takes place. Moreover the polarity of multicistronic transcription units (Moser, S. et al., Biotechnol Prog (2000) 16, 724-35, which is incorporated by reference in its entirety) leads probably to a balanced stoichiometry of the receptor genes and their expression rates in the range of 1:0.7 up to 1:1 for the first two positions whereas the blasticidin S deaminase gene compared to the receptor genes in the third position is expressed to a lesser extend.

Assuming that for the functional heterodimeric receptor ht1R2/ht1R3 a 1:1 stoichiometry is needed the lesser polarity effects for the receptor genes promote the desired stoichiometry whereas the reduced expression of the deaminase promotes an integration locus with enhanced transcriptional activity. Generation of stable hT1R2/hT1R3 expressing cells are performed by culturing the transfected cells in the presence of blasticidine.

For measurement of human T1R2/T1R3 taste receptor dependent activity a control cell line without sweet receptor based on HEK 293 and a cell line expressing the sweet receptor hT1R2/hT1R3 based on HEK 293, respectively, are seeded into assay plates and labelled with the calcium sensitive fluorescence dye Fluo4-AM in a culture medium. The potential modulators, e.g. the test compound, are added to the control cell line and to the cell line expressing the sweet receptor hT1R2/hT1R3, respectively.

Response to different concentrations of the modulator in the presence of fructose is recorded as Fluo4-AM fluorescence increase initiated through the hT1R2/hT1R3 dependent increase of the second messenger calcium. The applied fructose concentration is chosen from the results of preexaminations showing that fructose, in these concentrations, is barely activating the sweet taste receptors within this cell based assay. Thus a sweetness enhancing property of a test compound is detectable in the presence of the sweetener fructose.

### 1.2 Preparation of the Cell Lines and Cell Culture

A stable cell line based on HEK293 was termed HEKα15#17 served as control for functional Gα-protein and a stable cell line HEKGα15#17R2R3b#8 C6 served as cell line expressing the sweet receptor hT1R2/hT1R3 based on HEKGα15#17.

The cells were cultured in DMEM/HG and 10% FCS Gold, 4 mM L-Glutamin, 1.3 mg/ml Geneticin (HEKGα15#17) or the same medium additionally containing 6 μg/ml Blasticidin (HEKGα15#17R2R3b#8 C6). The medium for the assay was DMEM/HG (high glucose, 4.5 g/l glucose, Life Technologies) and 10% FCS Gold, 4 mM L-Glutamin (HEKGα15#17) or DMEM/LG (low glucose, 1 g/l glucose; Life Technologies) and 10% FCS Gold (HEKGα15#17R2R3b#8C6), respectively. 1.3 Evaluation of the sweet receptor modulating activity of rosmarinic acid

In order to evaluate the sweet receptor modulating activity of rosmarinic acid, rosmarinic acid was added to the cultures in a concentration of 25 μM in a volume of 50 μl. Controls were KH-buffer (Krebs HEPES-buffer: 118 mM NaCl, 4.7 mM KCl, 1.2 mM MgSO₄, 1.2 mM KH₂PO₄, 4.2 mM NaHCO₃, 1.3 mM CaCl₂, 10 mM Hepes, pH 7.4) either without or with sweetness enhancer. As natural and artificial sweeteners either fructose (20 mM), acesulfam K (30 mM) or sodium cyclamate (30 mM) were used.

Further controls for function of G-protein and receptor were isoproterenol Sigma Aldrich), ionomycin (1 μM, Calbiochem) and ATP (1 μM, Applichem).

DMSO was diluted in KH-buffer/fructose (100 mM stock solution=50 μM final test concentration=1:400 dilution).

### 1.4 In Vitro Cell Based Assay Procedure

For measurement of human T1R2/T1R3 taste receptor dependent activity, on day 1 of the test procedure the HEKα15#17 cells (control cell line without sweet receptor) and the HEKGα15#17R2R3b#8 C6 cells (cell line expressing the sweet receptor hT1R2/hT1R3), respectively, were transferred to low-glucose medium.

On day 2 the cells were seeded into assay plates at a density of 25.000 cells/well. Assay plates for fluorescence measurement (black clear bottom 96-cavity plates, Greiner Bio-One) were coated with poly-D-lysine. For direct comparison both cell lines (control cell line without sweet receptor and cell line expressing the sweet receptor hT1R2/hT1R3) were seeded into different cavities of the same assay plate. The plate was placed into the incubator for 48 hours at 37° C., 5% CO₂, 100% relative humidity.

On day 4 the calcium assay was performed. For this assay, the cells were marked with Fluo4-AM in medium and KH-buffer. To each cavity 100 μl KH-Puffer/250 μM sulfinpyrazone/4 μM Fluo4-AM were added gently to 100 μl medium (final concentration of Fluo4-AM=2 μM, stock solution of Fluo4-AM 1 mM in DMSO, excitation at 485 nm, emission at 520 nm, Fisher Scientific, 58239 Schwerte, Germany).

The plate was placed into the incubator for 1 hour. In the mean time the test substances (“ligands”) were prepared in a separate plate (5 times concentrated, 150 μl/cavity, and then automatically 50 μl/cavity were transferred into the screening cell plate by pipetting robot (FLEX-station, Molecular Devices, Sunnyvale, Calif.).

The culture medium was carefully removed and 200 μl KH-buffer/250 μM sulfinpyrazone per cavity was added slowly. Cells were left in the FLEX-station for 20 minutes for adaptation, followed by measurement at 37° C.

### 1.5 Results of the In Vitro Cell Based Assay

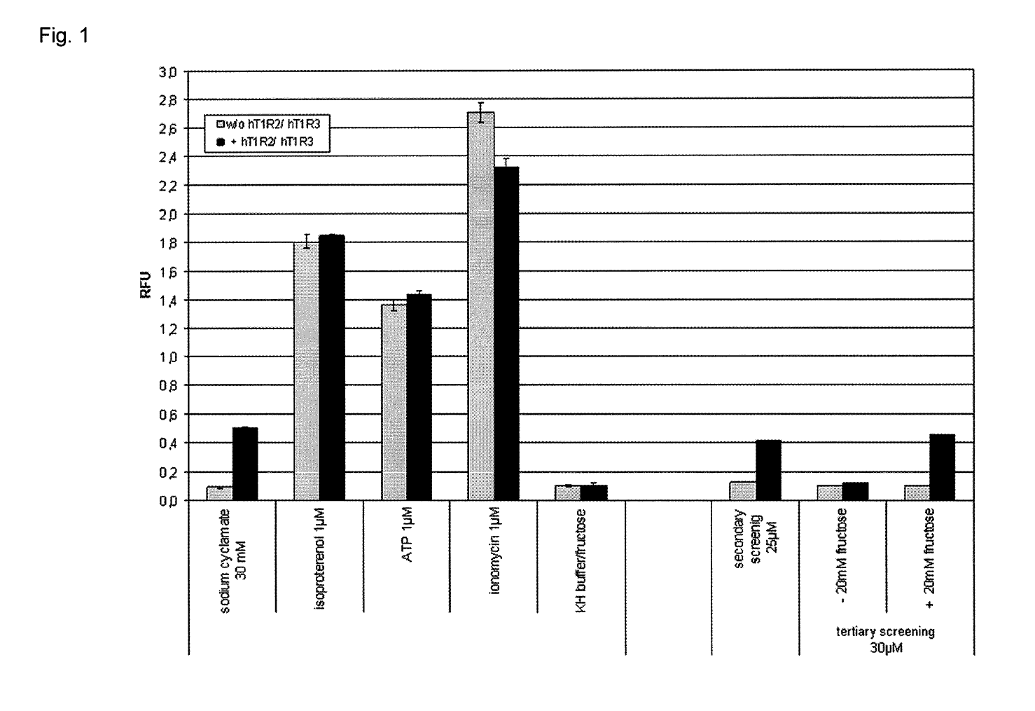

The results of this assay are shown in the bar diagram of FIG. 1. In the bar diagram the grey bars (control—without hT1R2/hT1R3) indicate the measured Fluo4-AM fluorescence increase of the respective test compound added to the control cell line, the black bars (assay—with hT1R2/hT1R3) indicate the measured Fluo4-AM fluorescence increase of the respective test compound added to the cell line expressing the sweet receptor hT1R2/hT1R3.

The first bar (sodium cyclamate) shows that the control sweetener sodium cyclamate does not activate the control cell line, but activates the cell line expressing the sweet receptor hT1R2/hT1R3. Consequently, this bar shows that sodium cyclamate is a sweetener.

The second, third and fourth bars (isoproterenol, ATP and ionomycin) show that the respective control compounds activate both the control and the cell line expressing the sweet receptor hT1R2/hT1R3 and confirm the function of the G-protein and receptor.

The fifth bar (KH buffer/fructose) represents the result of a screening, in which fructose was added in a concentration in that it does neither activate the control cell line, nor the cell line expressing the sweet receptor hT1R2/hT1R3.

The seventh bar (secondary screening) shows that rosmarinic acid in the presence of fructose does not activate the control cell line but activates the cell line expressing the sweet receptor hT1R2/hT1R3. Consequently, rosmarinic acid is a sweetener and/or a fructose enhancer.

The eighth bar (rosmarinic acid without fructose) shows that rosmarinic acid does not activate the control cell line, nor the cell line expressing the sweet receptor hT1R2/hT1R3. Consequently, rosmarinic acid is not a sweetener.

The ninth bar (rosmarinic acid in the presence of fructose) shows that rosmarinic acid does not activate the control cell line, but activates the cell line expressing the sweet receptor hT1R2/hT1R3 and enhances the activity of fructose.

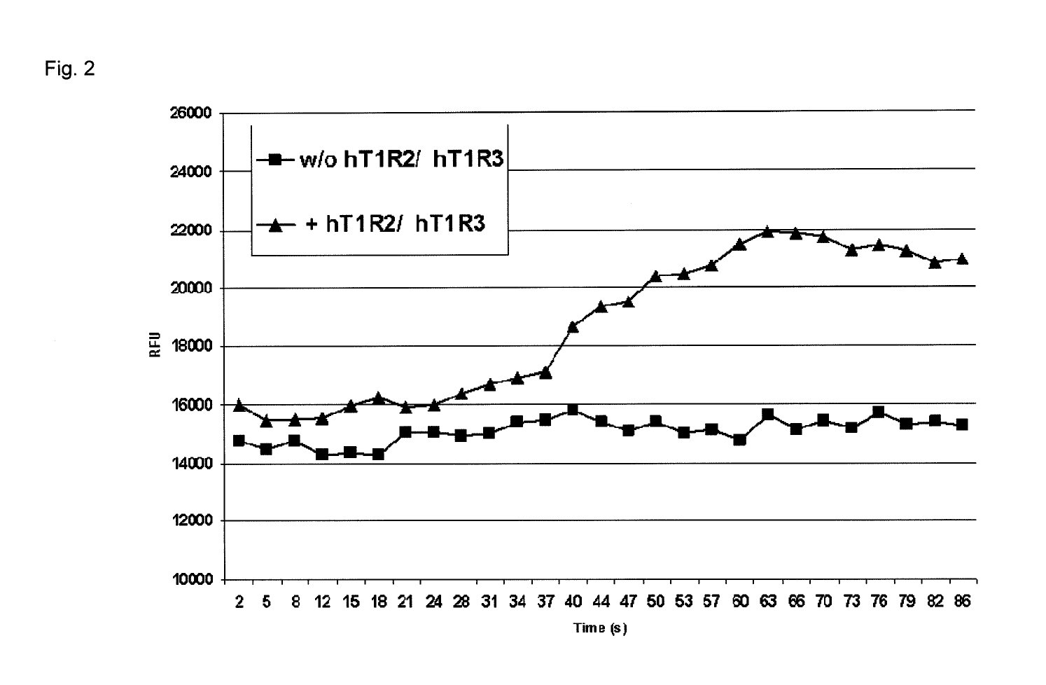

FIG. 2 shows that the selective stimulation of receptor carrying cells by rosmarinic acid is verified by measuring the time response in the cell assay over a period of ca. 1.5 minutes (86 seconds).

Consequently, the assay shows that rosmarinic acid acts as a fructose enhancer in the cell based in vitro assay.

### Example 2

### Taste and Spit Assay with Rosmarinic Acid

The taste of a sample of rosmarinic acid with regard to sweetness and fructose enhancing features was assessed by using a panel of trained sensory evaluators experienced in the sweet taste estimation procedure. 5 individuals were asked to taste the quality of single samples of 10 ml volume.

2.1 General procedure

Panelists were asked to take a sample of the liquid to be assessed (20 μM test substance rosmarinic acid in 0.5% ethanol) into the mouth and after some time allowed for taste perception to spit the sample out completely. Subsequently, the panelists were asked to rinse their mouth well with water or black tea to reduce any potential carry over effects. The tasting of a sample could be repeated if required.

### 2.2 Taste and Spit Phase I—Qualitative Assessment

In a first descriptive test 5 individuals were asked to taste the quality of single samples of 10 ml volume (maximum 3 subsequent samples). The samples were served at ambient temperature. The individuals of the taste panel were asked to answer the following questions with regard to the quality of taste: 1) does the sample taste sweet?, 2) is there another taste detectable (bitter, sour, salty, umami)?, 3) is there an off- or aftertaste?, 4) is there anything else remarkable about the perception of the sample?

Results: All panelists identified the sample containing rosmarinic acid as having no characteristic taste at the indicated concentration. No off-taste or any other taste than sweetness was detected by the taste panel.

### 2.3 Taste and Spit Phase II—Assessment of Fructose Enhancing Features

In the next step the panelists were asked to answer questions in a pairwise comparison test to determine the enhancement of sweet taste of the test substance with fructose relative to fructose only. 5 individuals were given samples of 10 ml volume. This time two samples were prepared for direct comparison regarding sweetness. One sample contained fructose (4%) in solvent (0.5% ethanol) and the other sample additionally contained 20 μM of the test substance rosmarinic acid. Designation of the samples with A and B was randomized and decoded after the taste procedure. The questions to be answered were: 1) does one sample taste sweeter than the other?, 2) if so, which one?, 3) are there any other differences in the taste between the two samples?

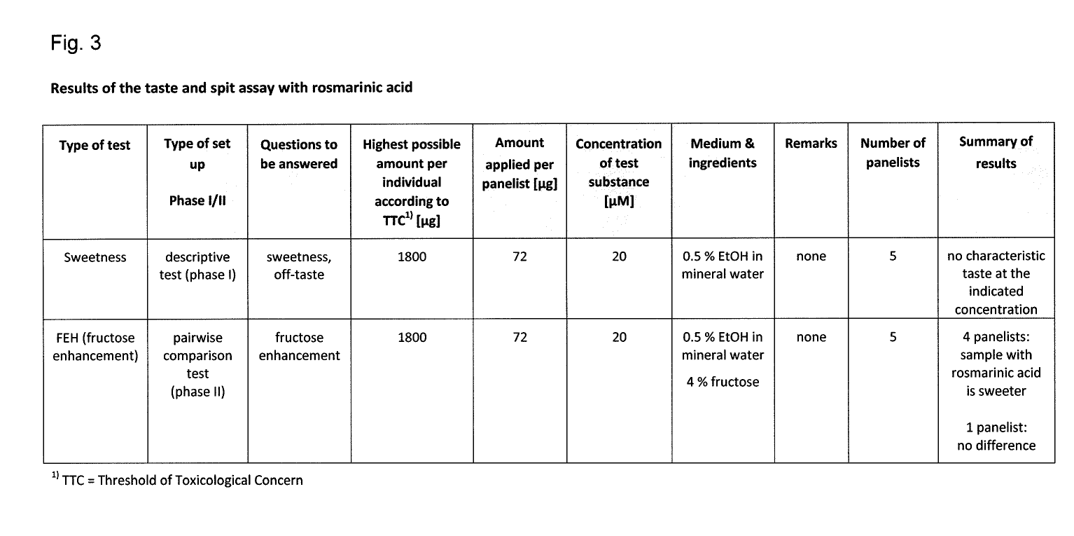

Results: The results of the taste and spit assay are based on a qualitative evaluation of the differences between the two samples (cf. FIG. 3). In the assessment of fructose enhancing features at a concentration of 20 μM rosmarinic acid, four panelists identified the sample containing 4% fructose with rosmarinic acid as sweeter than the sample containing 4% fructose only. One panelist tasted no difference. Table 1 of FIG. 3 shows that rosmarinic acid is perceived as a fructose enhancer.

We claim:

1. A sweetener composition, comprising
a sweetener; and
rosmarinic acid or a derivative or a stereoisomer or a salt or a hydrate thereof.

2. The sweetener composition of claim 1, wherein 1 gram of the sweetener composition has a sweetness comparable to from one to three teaspoons of granulated sugar.

3. The sweetener composition of claim 1, wherein 1 gram of the sweetener composition contains less calories and carbohydrates than about 1 gram of granulated sugar.

4. The sweetener composition of claim 1, wherein rosmarinic acid has no off-taste, as determined by a tasting panel.

5. The sweetener composition of claim 4, wherein the sweetener composition is substantially free of off-taste, as determined by a tasting panel.

6. The sweetener composition of claim 1, wherein the sweetener composition is a liquid at ambient conditions.

7. The sweetener composition of claim 1, wherein the sweetener composition is a solid at ambient conditions.

8. The sweetener composition of claim 1, wherein the sweetener composition comprises homogeneous particles comprising the sweetener and rosmarinic acid or a derivative or a stereoisomer or a salt or a hydrate thereof.

9. The sweetener composition of claim 8, wherein the sweetener particles have an average particle size of between about 50 microns and about 1250 microns.

10. The sweetener composition of claim 1, wherein the sweetener composition comprises a mixture of first particles comprising the sweetener and second particles comprising rosmarinic acid or a derivative or a stereoisomer or a salt or a hydrate thereof.

11. The sweetener composition of claim 1, comprising from 0.0005 wt % to 1.0 wt % of rosmarinic acid or a derivative or a stereoisomer or a salt or hydrate thereof, based on the total weight of the sweetener composition.

12. The sweetener composition of claim 1, wherein the sweetener is selected from the group consisting of sucrose, fructose, glucose, high fructose corn syrup, xylose, arabinose, rhamnose, erythritol, xylitol, mannitol, sorbitol, inositol, acesulfame potassium, aspartame, neotame, sucralose, saccharine, saccharine derivatives, naringin dihydrochalcone (NarDHC), neohesperidin dihydrochalcone (NDHC), rubusoside, rebaudioside, stevioside, mogroside IV, siamenoside I, mogroside V, iso-mogroside V and trilobtain.

13. The sweetener composition of claim 1, wherein the sweetener is fructose.

14. The sweetener composition of claim 1, wherein the sweetener composition comprises a first sweetener and a second sweetener.

15. The sweetener composition of claim 14, wherein the first sweetener is fructose and the second sweetener is a natural sweetener.

16. The sweetener composition of claim 1, wherein the sweetener is an artificial sweetener.

17. The sweetener composition of claim 1, wherein the sweetener is a natural sweetener.

18. A tabletop sweetener composition, comprising:
(a) a disaccharide carbohydrate and/or fructose;
(b) erythritol;
(c) rosmarinic acid or a derivative or a stereoisomer or a salt or a hydrate thereof; and
(d) cellulose.

19. A tabletop sweetener composition according to claim 18, wherein the disaccharide carbohydrate is selected from the group consisting of sucrose, lactose, maltose, trehalose, and isomaltulose.

20. A tabletop sweetener composition according to claim 18, wherein the tabletop sweetener composition comprises from about 40% by weight to about 70% by weight erythritol.

21. A tabletop sweetener composition according to claim 18, wherein the tabletop sweetener composition comprises from about 27% by weight to about 50% by weight disaccharide carbohydrate.

22. A tabletop sweetener composition according to claim 18, wherein the tabletop sweetener composition comprises from about 0.5% by weight to about 7.0% by weight of rosmarinic acid or a derivative or a stereoisomer or a salt or a hydrate thereof.

23. A tabletop sweetener composition according to claim 18, wherein the tabletop sweetener composition comprises from about 0.4% by weight to about 3.0% by weight cellulose.

24. A tabletop sweetener composition according to claim 18 further comprising a sweetness modifier.

25. A tabletop sweetener composition according to claim 18 further comprising a mouthfeel enhancer.

26. A tabletop sweetener composition according to claim 18 further comprising a flavoring.

27. A tabletop sweetener composition according to claim 18, in the form of tabletop sweetener particles.

28. A tabletop sweetener composition according to claim 27, wherein the tabletop sweetener particles have an average particle size of between about 50 microns and about 1250 microns.

29. A tabletop sweetener composition according to claim 18, wherein the tabletop sweetener composition has less than about 5 calories per gram.

30. A tabletop sweetener composition, comprising:
(a) a plurality of first sweetener particles, wherein the first sweetener particles have (i) an erythritol core, (ii) a first erythritol core-coating layer comprising rosmarinic acid or a derivative or a stereoisomer or a salt or a hydrate thereof and cellulose, and (iii) a second erythritol core-coating layer comprising a disaccharide carbohydrate, where the second erythritol core-coating layer lies outside of the first erythritol core-coating layer; and
(b) a plurality of second sweetener particles, where the second sweetener particle has (i) a disaccharide core, (ii) a first disaccharide core-coating layer comprising rosmarinic acid or a derivative or a stereoisomer or a salt or a hydrate thereof and cellulose, and (iii) a second disaccharide core-coating layer comprising a disaccharide carbohydrate, where the second disaccharide core-coating layer lies outside of the first disaccharide core-coating layer.

31. A tabletop sweetener composition according to claim 30, wherein the disaccharide core comprises isomaltulose.

32. A tabletop sweetener composition according to claim 30, wherein the second erythritol core-coating layer comprises isomaltulose.

33. A tabletop sweetener composition according to claim 30, wherein the second disaccharide core-coating layer comprises isomaltulose.

34. A tabletop sweetener composition according to claim 30, wherein the first erythritol core-coating layer and the first disaccharide core-coating layer further comprise a flavoring.

35. A tabletop sweetener composition according to claim 30, wherein the first erythritol core-coating layer and the first disaccharide core-coating layer further comprise a mouthfeel enhancer.

36. A tabletop sweetener composition according to claim 30, wherein the first erythritol core-coating layer and the first disaccharide core-coating layer further comprise a sweetness modifier.

37. A tabletop sweetener composition according to claim 30, wherein the plurality of first sweetener particles and the plurality of second sweetener particles have an average particle size between about 50 microns and about 1250 microns.

38. A method of providing a sweetened consumable comprising the step of admixing with a consumable product a tabletop sweetener composition comprising:
(i) a disaccharide carbohydrate and/or fructose;
(ii) erythritol;
(iii) rosmarinic acid or a derivative or a stereoisomer or a salt or a hydrate thereof; and
(iv) cellulose.

39. A method of enhancing the taste sensations associated with flavor ingredients, comprising the step of admixing rosmarinic acid or a derivative or a stereoisomer or a salt or a hydrate thereof with one or more flavor ingredients to provide a flavor-enhanced composition or consumable product.

40. The method of claim 39, wherein the flavor ingredient is a sweetener.

41. The method of claim 40, wherein the sweetener is selected from the group consisting of sucrose, fructose, glucose, high fructose corn syrup, xylose, arabinose, rhamnose, erythritol, xylitol, mannitol, sorbitol, inositol, acesulfame potassium, aspartame, neotame, sucralose, saccharine, naringin dihydrochalcone (NarDHC), neohesperidin dihydrochalcone (NDHC), rubusoside, rebaudioside A, stevioside, mogroside IV, siamenoside I, mogroside V, iso-mogroside V and trilobtain.

42. A process for enhancing the sweetness of a sweetener composition comprising a sweetener, comprising the step of:
(a) adding to the sweetener rosmarinic acid or a derivative or a stereoisomer or a salt or a hydrate thereof to form an enhanced sweetener composition.

43. The process of claim 42, wherein the adding comprises adding to the sweetener a rosmarinic acid in an amount effective to increase the sweetness of the sweetener composition to an increased sweetness level.

44. A consumable product composition, comprising:
a consumable product;
a sweetener; and
rosmarinic acid present in an amount effective to increase a sweetness level of the composition.

45. The consumable product composition of claim 44, wherein rosmarinic acid or a derivative or a stereoisomer or a salt or a hydrate thereof is present in the consumable product composition in a concentration from 0.1 wppm to 100 wppm.

46. The consumable product composition of claim 44, wherein the consumable product is a water-based consumable selected from the group consisting of beverages, water, aqueous beverages, enhanced/slightly sweetened water drinks, mineral waters, carbonated beverages, non-carbonated beverages, carbonated waters, still waters, soft drinks, non-alcoholic drinks, alcoholic drinks, beer, wine, liquor, fruit drinks, juices, fruit juices, vegetable juices, broth drinks, coffees, teas, black teas, green teas, oolong teas, herbal teas, cacoa, tea-based drinks, coffee-based drinks, cacao-based drinks, syrups, frozen fruits, frozen fruit juices, water-based ices, fruit ices, sorbets, dressings, salad dressings, sauces, soups, beverage botanical materials, and instant powders for reconstitution.

47. The consumable product composition of claim 44, wherein the consumable product is a solid dry consumable selected from the group consisting of cereals, baked food products, biscuits, breads, breakfast cereals, cereal bars, energy bars/nutritional bars, granolas, cakes, rice cakes, cookies, crackers, donuts, muffins, pastries, confection, chewing gums, chocolates, fondants, hard candies, marshmallows, pressed tablets, snack foods, botanical materials, and instant powders for reconstitution.
